(19) United States
(12) Patent Application Publication
(10) Pub. No.: US 2024/0345122 A1
(43) Pub. Date: Oct. 17, 2024

(54) FLUID TRANSFER IN A BIOLOGICAL ANALYSIS SYSTEM

(71) Applicant: Beckman Coulter, Inc., Miami, FL (US)

(72) Inventors: Craig VEINER, Cincinnati, OH (US); Bart Wanders, Tabuco Canyon, CA (US); Sirui Cai, Redwood City, CA (US); Marco Zuleta, Miami, FL (US)

(21) Appl. No.: 18/750,704

(22) Filed: Jun. 21, 2024

Related U.S. Application Data
(63) Continuation of application No. PCT/US2022/053753, filed on Dec. 22, 2022.
(60) Provisional application No. 63/292,806, filed on Dec. 22, 2021.

(51) Int. Cl. G01N 35/10; G01N 1/14; G01N 1/38

(52) U.S. Cl. CPC G01N 35/1097; G01N 1/14; G01N 2001/383; G01N 2035/1032

(57) ABSTRACT

A biological analysis system includes a probe. The probe is configured to dispense a biological sample into a first chamber. The system also includes a pump. The pump is configured to convey a first delivery of diluent to the first chamber for mixing with the biological sample to produce a sample mixture, aspirate a portion of the sample mixture from the first chamber, and convey the portion of the sample mixture to a second chamber. A method of analyzing a biological sample includes conveying a diluent to a first chamber via a first pump, dispensing a blood sample into the first chamber via a probe to produce a sample mixture, and conveying a portion of the sample mixture from the first chamber to a second chamber via the first pump.

### PRIORITY

This is a continuation of, and claims the benefit of, international patent application PCT/US22/53753, entitled “Fluid Transfer in a Biological Analysis System,” filed Dec. 22, 2022, which itself claims the benefit of U.S. Pat. App. No. 63/292,806, entitled “Fluid Transfer in a Biological Analysis System,” filed Dec. 22, 2022, the disclosure of which is incorporated by reference herein.

### BACKGROUND

Various types of tests related to patient diagnosis and therapy can be performed by analysis of patient samples. This could include analysis of the patient's microorganisms, or “microbes,” as well as analysis of samples to determine chemistry, antigen, antibodies, blood cell count, and other factors that may influence patient health. Microbes are microscopic living organisms such as bacteria, fungi, or viruses, which may be single-celled or multicellular. When analyzing microbes, biological samples containing the patient's microorganisms may be taken from a patient's infections, bodily fluids, or abscesses and may be placed in test panels or arrays, combined with various reagents, incubated, and analyzed to aid in treatment of the patient. Analysis of patient chemistry, immunoassay, blood cell count, and other characteristics may be similarly performed. For these varying analyses, automated biochemical analyzers or biological testing systems have been developed to meet the needs of health care facilities and other institutions to facilitate analysis of patient samples and to improve the accuracy and reliability of results when compared to analysis using manual operations and aid in determining effectiveness of various antimicrobials.

Biological samples are commonly dispensed into various chambers for analysis, processing, and/or testing therein. For example, a hematology analyzer may be equipped with a sample probe (also referred to as an aspirate-and-dispense probe), which may aspirate a biological sample (e.g., blood) from a specimen and then dispense the biological sample into a first bath (e.g., a white blood cell bath). The probe may subsequently aspirate a portion of the sample solution from the first bath and then dispense the aspirated portion into a second bath (e.g., a red blood cell bath), such that the portions of the sample solutions in the first and second baths may be analyzed separately from each other. Thus, the probe must navigate along a path that includes at least the specimen, the first bath, and the second bath. Such a path may be complex and/or may have a relatively large footprint, such that the size of the analyzer may need to be undesirably large in order to accommodate the path. The probe also must perform at least four separate tasks in series (e.g., a first aspiration, a first dispensing, a second aspiration, and a second dispensing) to facilitate delivery of the sample solution to each of the baths. Such reliance on the probe for all of these tasks may hinder the probe from performing other functions, such as facilitating further analysis (e.g., measuring, imaging, and/or flow imaging) of red blood cells (RBC), white blood cells (WBC), and platelets (PLT) and/or may undesirably limit the throughput of the analyzer.

### SUMMARY

In some embodiments, a biological analysis system which includes a probe is described. The probe is configured to dispense a biological sample into a first chamber. The system also includes a pump. The pump is configured to convey a first delivery of diluent to the first chamber for mixing with the biological sample to produce a sample mixture, aspirate a portion of the sample mixture from the first chamber, and convey the portion of the sample mixture to a second chamber. In some embodiments, the probe is configured to aspirate the biological sample from a biological specimen prior to dispensing the biological sample into the first chamber. In addition, or alternatively, the pump may include a syringe pump. The system may include a CBC drip chamber, wherein the CBC drip chamber is configured to count blood cells within at least one of the first or second chambers. In addition, or alternatively, the pump may be configured to convey a second delivery of diluent to the second chamber while conveying the portion of the sample mixture to the second chamber. The system may include a lyse pump, wherein the lyse pump is configured to convey a lyse to one of the chambers. The system may include the first and second chambers, wherein the first and second chambers are configured to be selectively fluidly coupled to each other. The system may further include a transfer line configured to selectively fluidly couple the first and second chambers to each other, and the pump may be configured to aspirate the portion of the sample mixture into the transfer line prior to conveying the portion of the sample mixture to the second chamber through the transfer line. The system may further include at least one diluent push/pull line configured to be selectively fluidly coupled to the transfer line, and the pump may be configured to draw an air gap into the at least one diluent push/pull line while aspirating the portion of the sample mixture into the transfer line.

In some embodiments, a biological analysis system which includes a first chamber, a second chamber, and a probe is described. The probe is configured to dispense a biological sample into the first chamber. The system also includes a first pump. The first pump is configured to transfer a portion of the biological sample from the first chamber to the second chamber. The system also includes a second pump. The second pump is configured to convey a fluid medium to at least one of the first chamber or the second chamber. In some embodiments, the fluid medium includes a lyse, wherein the second pump is configured to convey the lyse to the first chamber after transfer of the portion of the biological sample to the second chamber. The system may further include a CBC drip chamber, wherein the CBC drip chamber is fluidly coupled to at least one of the first or second chambers for counting blood cells within the at least one of the first or second chambers. In addition, or alternatively, the first pump may be configured to convey a first delivery of diluent to the first chamber for mixing with the biological sample to produce a sample mixture prior to transfer of the portion of the biological sample to the second chamber. The first pump may be configured to convey a second delivery of diluent to the second chamber during transfer of the portion of the biological sample to the second chamber. In some embodiments, the first and second chambers are configured to be selectively fluidly coupled to each other. The system may further include a transfer line configured to selectively fluidly couple the first and second chambers to each other, and at least one diluent push/pull line configured to be selectively fluidly coupled to the transfer line, and the first pump may be configured to draw an air gap into the at least one diluent push/pull line while aspirating the portion of the biological sample into the transfer line. In some embodiments, the first chamber comprises a hemoglobin transducer. The hemoglobin transducer may include a filtered light source and an optical sensor.

In some embodiments, a method of analyzing a biological sample is described. A method of analyzing a biological sample includes conveying a diluent to a first chamber via a first pump, dispensing a blood sample into the first chamber via a probe to produce a sample mixture, and conveying a portion of the sample mixture from the first chamber to a second chamber via the first pump. The method may further include conveying a lyse to the first chamber or the second chamber via a second pump.

### BRIEF DESCRIPTION OF THE DRAWINGS

While the specification concludes with claims which particularly point out and distinctly claim the invention, it is believed the present invention will be better understood from the following description of certain examples taken in conjunction with the accompanying drawings, in which like reference numerals identify the same elements and in which:

FIG. 1 depicts a schematic view of an exemplary biological analysis system;

FIG. 2A depicts a schematic view of the biological analysis system of FIG. 1, showing flushing of WBC and RBC baths of the system via a wash pump and a waste pump to cleanse the WBC and RBC baths of waste fluids contained therein using a diluent;

FIG. 2B depicts a schematic view of the biological analysis system of FIG. 1, showing a delivery of diluent to the WBC bath via the wash pump;

FIG. 2C depicts a schematic view of the biological analysis system of FIG. 1, showing a delivery of a blood sample to the WBC bath via a probe of the system;

FIG. 2D depicts a schematic view of the biological analysis system of FIG. 1, showing another delivery of diluent to the WBC bath via the wash pump to produce a predilute solution in the WBC bath;

FIG. 2E depicts a schematic view of the biological analysis system of FIG. 1, showing an extraction of a portion of the predilute solution from the WBC bath via the wash pump;

FIG. 2F depicts a schematic view of the biological analysis system of FIG. 1, showing a delivery of a transfer portion of the predilute solution to an RBC input line of the system via the wash pump;

FIG. 2G depicts a schematic view of the biological analysis system of FIG. 1, showing a delivery of lyse to the WBC bath via a lyse pump of the system;

FIG. 2H depicts a schematic view of the biological analysis system of FIG. 1, showing another delivery of diluent to the WBC bath via the wash pump to produce a final WBC solution;

FIG. 2I depicts a schematic view of the biological analysis system of FIG. 1, showing delivery of diluent and the transfer portion of the predilute solution to the RBC bath via the wash pump;

FIG. 3 depicts a method of analyzing a biological sample using the biological analysis system of FIG. 1;

FIG. 4 depicts a schematic view of another exemplary biological analysis system;

FIG. 5A depicts a schematic view of the biological analysis system of FIG. 4, showing a delivery of a blood sample to a WBC bath of the system via a probe of the system, diluent having been previously delivered to the WBC bath via a diluent pump of the system, and further showing a delivery of mixing bubbles of air to the WBC bath via a mix pump of the system to produce a predilute solution in the WBC bath, a delivery of diluent to a sweep flow tank of the system via a wash pump of the system, and a charging of the diluent pump with diluent;

FIG. 5B depicts a schematic view of the biological analysis system of FIG. 4, showing an extraction of a portion of the predilute solution from the WBC bath via the diluent pump;

FIG. 5C depicts a schematic view of the biological analysis system of FIG. 4, showing a delivery of diluent and a transfer portion of the predilute solution to an RBC bath of the system via the diluent pump to produce a final RBC solution, and further showing a delivery of lyse to the WBC bath via a lyse pump of the system and another delivery of mixing bubbles of air to the WBC bath via the mix pump to produce a final WBC solution;

FIG. 5D depicts a schematic view of the biological analysis system of FIG. 4, showing a delivery of mixing bubbles of air to the RBC bath via the mix pump to assist with producing the final RBC solution;

FIG. 5E depicts a schematic view of the biological analysis system of FIG. 4, showing a delivery of diluent from the sweep flow tank to a complete blood count (CBC) chamber of the system;

FIG. 5F depicts a schematic view of the biological analysis system of FIG. 4, showing a charging of the diluent pump with diluent;

FIG. 5G depicts a schematic view of the biological analysis system of FIG. 4, showing flushing of the RBC bath via the wash pump, the diluent pump, and a waste pump to cleanse the RBC bath of waste fluids contained therein using diluent;

FIG. 5H depicts a schematic view of the biological analysis system of FIG. 4, showing flushing of the WBC bath via the wash pump and the waste pump to cleanse the WBC bath of waste fluids contained therein using diluent;

FIG. 5I depicts a schematic view of the biological analysis system of FIG. 4, showing another charging of the diluent pump with diluent, and further showing a forming of an air gap via the diluent pump;

FIG. 5J depicts a schematic view of the biological analysis system of FIG. 4, showing a delivery of diluent to the WBC bath via the diluent pump; and

FIG. 6 depicts a method of analyzing a biological sample using the biological analysis system of FIG. 4.

The drawings are not intended to be limiting in any way, and it is contemplated that various embodiments of the invention may be carried out in a variety of other ways, including those not necessarily depicted in the drawings. The accompanying drawings incorporated in and forming a part of the specification illustrate several aspects of the present invention, and together with the description serve to explain the principles of the invention; it being understood, however, that this invention is not limited to the precise arrangements shown.

### DETAILED DESCRIPTION

The following description of certain examples of the invention should not be used to limit the scope of the present invention. Other examples, features, aspects, embodiments, and advantages of the invention will become apparent to those skilled in the art from the following description, which is by way of illustration, one of the best modes contemplated for carrying out the invention. As will be realized, the invention is capable of other different and obvious aspects, all without departing from the invention. Accordingly, the drawings and descriptions should be regarded as illustrative in nature and not restrictive.

It will be appreciated that any one or more of the teachings, expressions, versions, examples, etc. described herein may be combined with any one or more of the other teachings, expressions, versions, examples, etc. that are described herein. The following-described teachings, expressions, versions, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

Furthermore, the terms “about,” “approximately,” and the like as used herein in connection with any numerical values or ranges of values are intended to encompass the exact value(s) referenced as well as a suitable tolerance that enables the referenced feature or combination of features to function for the intended purpose described herein.

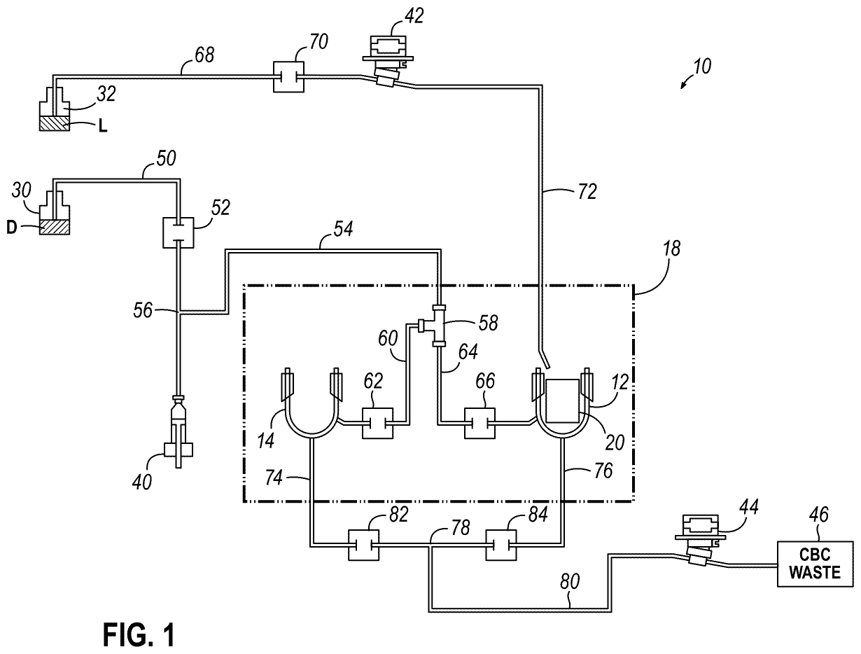

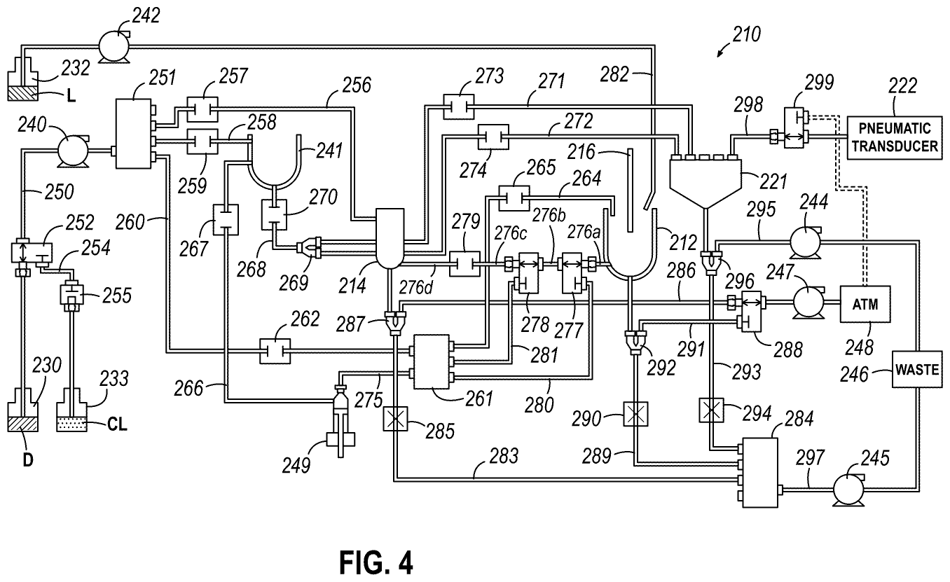

The present disclosure relates to apparatus, systems, compositions, and methods for analyzing biological samples. A first exemplary biological analysis system (10) and method (100) will be described in greater detail with reference to FIGS. 1-2I and FIG. 3, respectively; and a second exemplary biological analysis system (210) and method (300) will be described in greater detail with reference to FIGS. 4-5J and 6, respectively.

### A. FIRST EXEMPLARY BIOLOGICAL ANALYSIS SYSTEM EMBODIMENTS

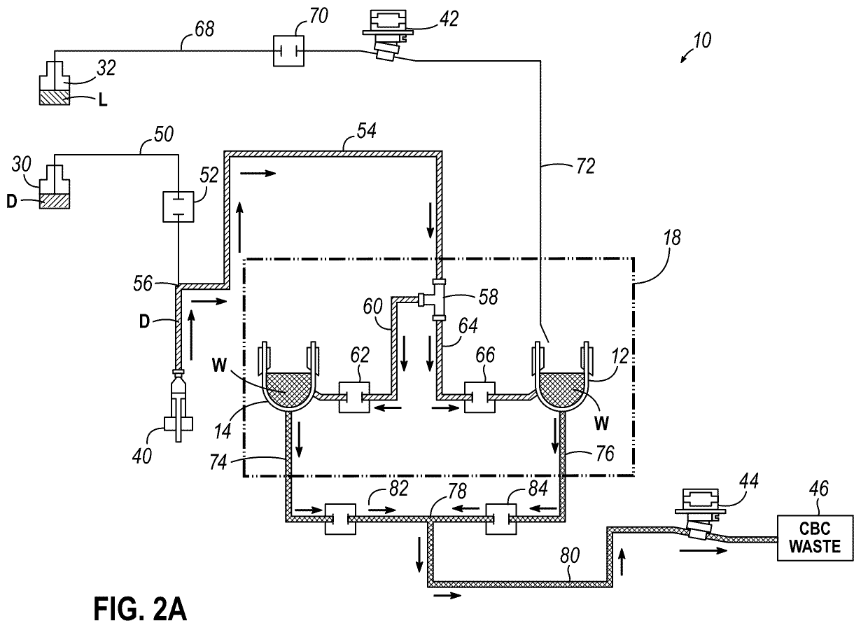

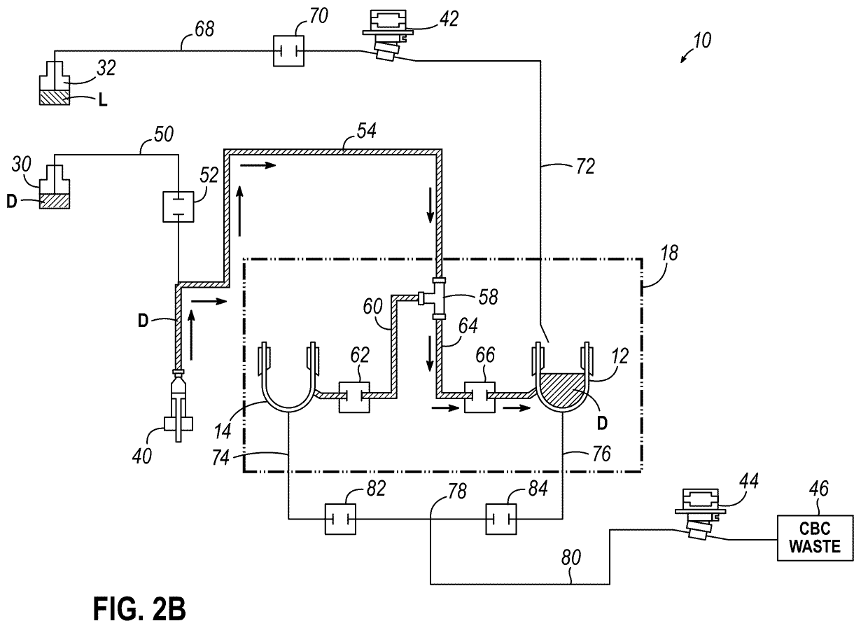

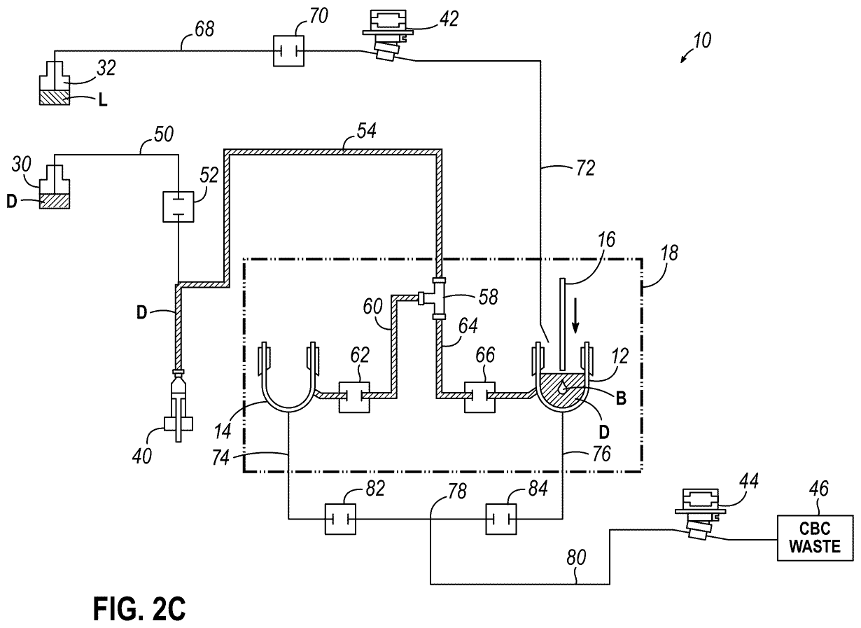

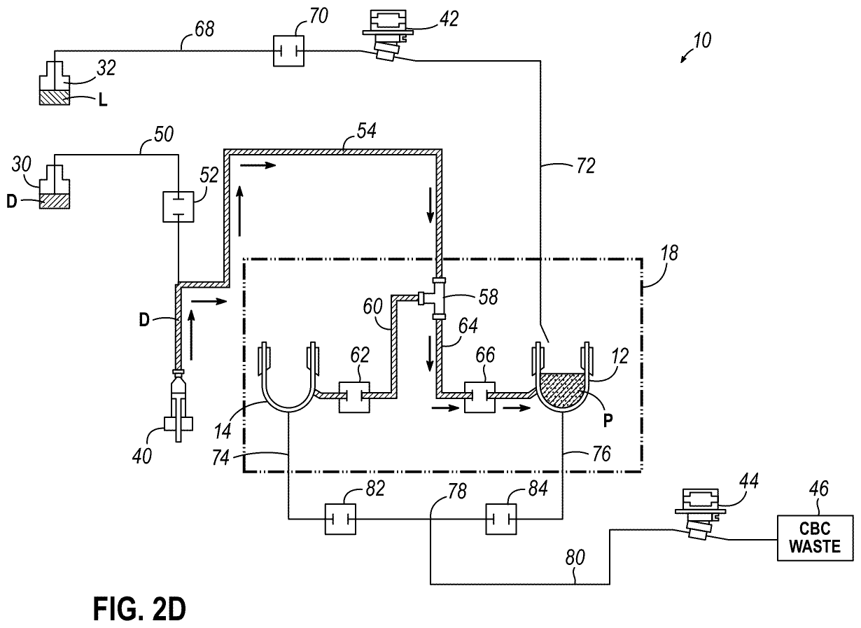

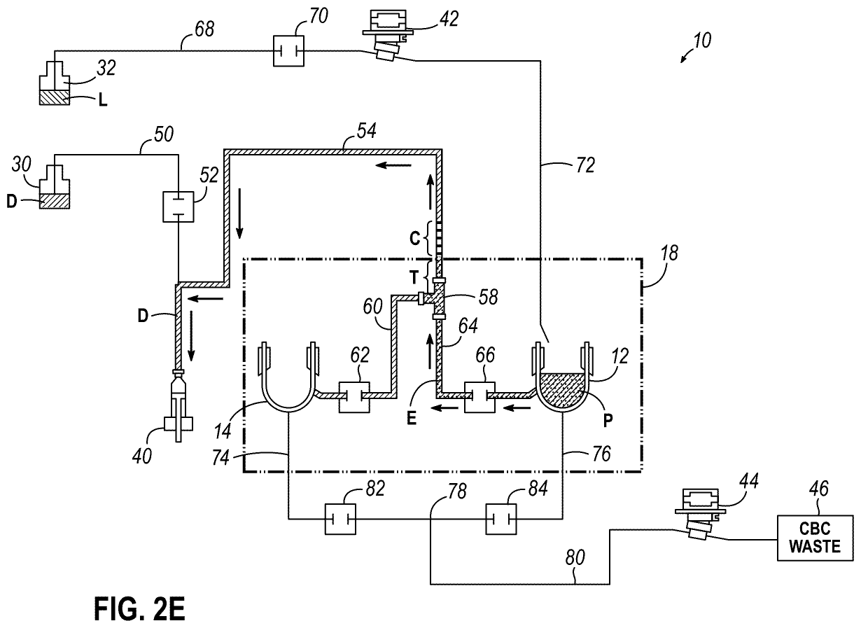

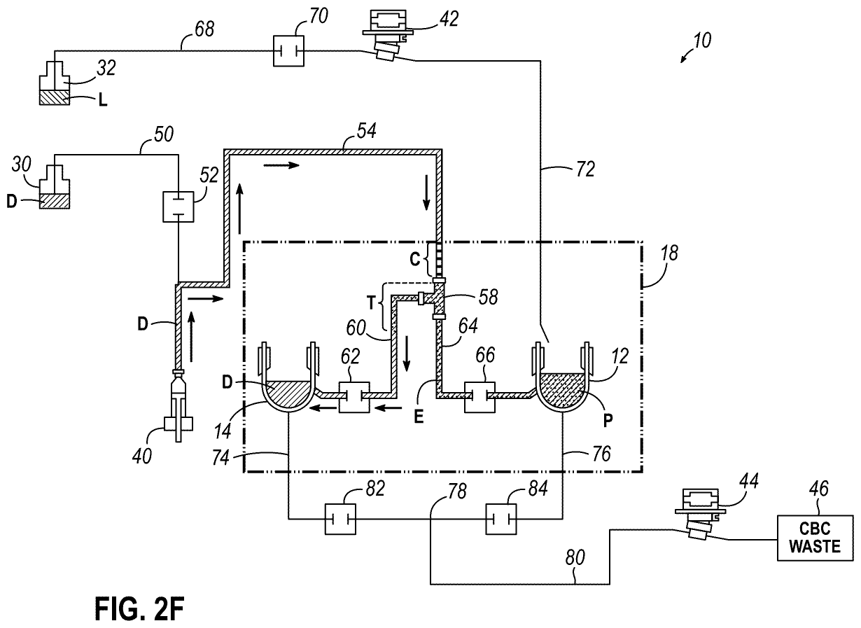

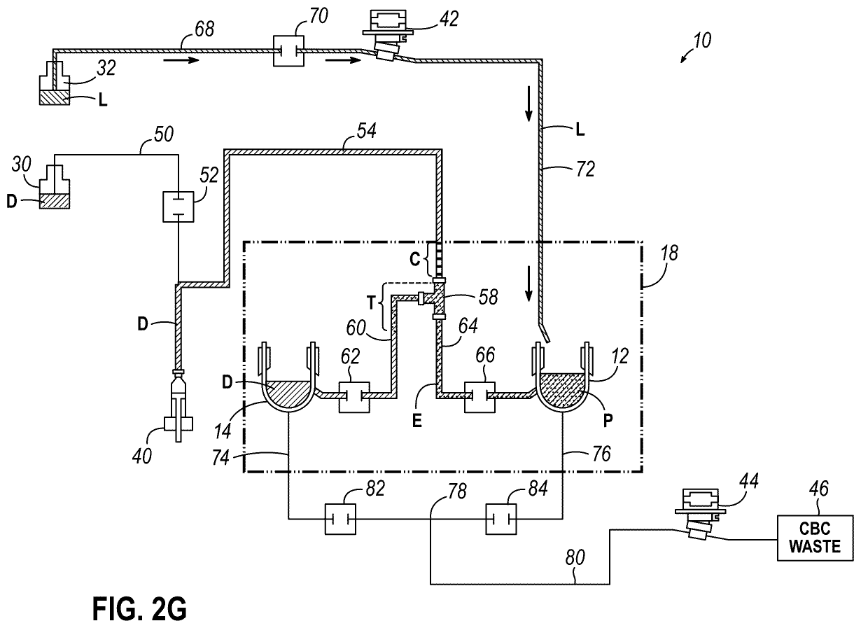

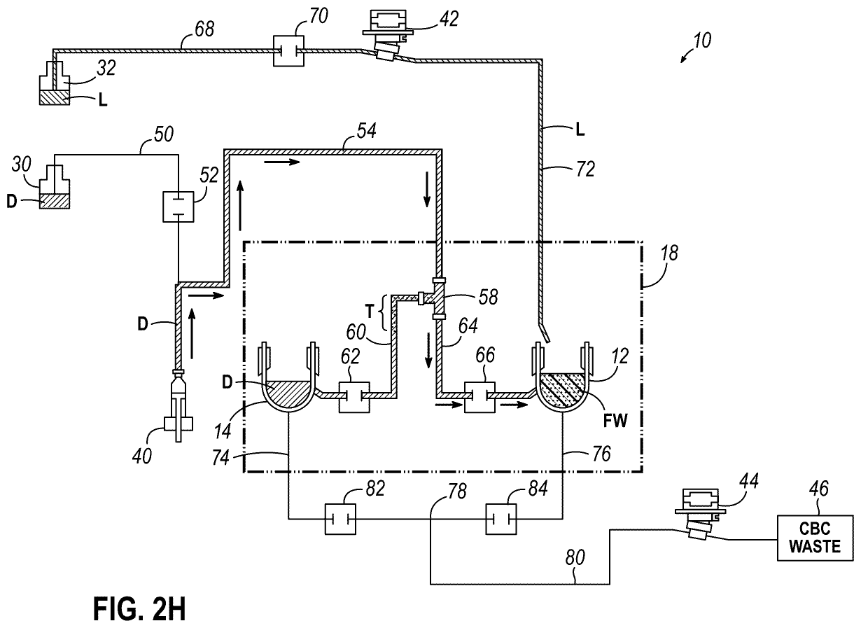

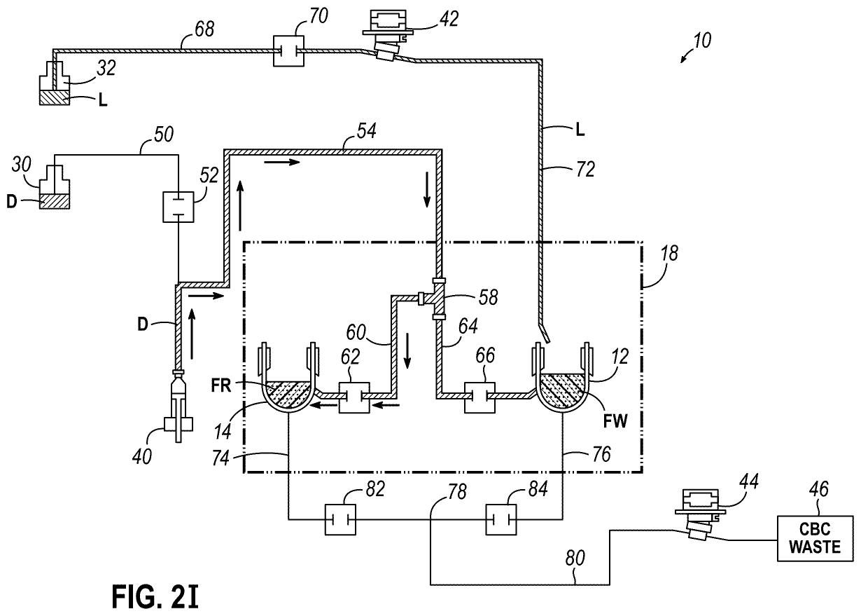

FIG. 1 shows an exemplary biological analysis system (10) that includes, among other components, a pair of fluid analysis chambers including a first fluid analysis chamber in the form of a first bath (12) and a second fluid analysis chamber in the form of a second bath (14). As shown in FIG. 1, first bath (12) is a white blood cell (WBC) or hemoglobin (HGB) bath and second bath (14) is a red blood cell (RBC) bath. In the example shown, each of the WBC and RBC baths (12, 14) is open for permitting a sample probe (16) (FIG. 2C) of the system (10) to selectively access one or both baths (12, 14), such as to aspirate fluid therefrom and/or dispense fluid thereto. In other embodiments, at least one of the WBC or RBC baths (12, 14) may be closed (e.g., such that sample probe (16) may not access at least one bath). In any event, the WBC and RBC baths (12, 14) of the present embodiment are housed within a shielded complete blood count (CBC) box (18).

The biological analysis system (10) is configured to analyze a biological sample. In some embodiments, the biological analysis system (10) is configured to analyze a blood sample (B) (FIG. 2C), such that the biological analysis system (10) may be referred to as a blood analysis system. In this regard, the WBC bath (12) of the present embodiment includes a hemoglobin transducer (20) configured to measure an amount of hemoglobin present in a fluid medium contained within the WBC bath (12). For example, the hemoglobin transducer (20) may include a light source (e.g., a filtered light source) and an optical sensor configured to receive optical signals emitted from the light source through the fluid medium contained within the WBC bath (12). In some embodiments, the WBC and RBC baths (12, 14) may each be fluidly coupled to a CBC drip chamber (not shown) housed within the shielded CBC box (18) via corresponding input and output conduits equipped with respective valves for selectively conveying fluid media from one of the WBC or RBC baths (12, 14) to the CBC drip chamber and/or for returning such fluid media from the CBC drip chamber to the WBC or RBC bath (12, 14). Such a CBC drip chamber may be configured to measure a complete blood count of the fluid media received from each bath (12, 14). In other embodiments, only one of the WBC or RBC baths (12, 14) (e.g., only the RBC bath (14)), may be fluidly coupled to such a CBC drip chamber. While analysis (e.g., impedance based counting, optical techniques, and/or imaging) of blood is shown and described herein, the biological analysis system (10) may analyze (and optionally image) a variety of fluids including, but not limited to, other bodily fluids such as synovial fluid, urine, bone marrow, etc.

As shown in FIG. 1, the biological analysis system (10) also includes a plurality of fluid reservoirs including a first fluid reservoir in the form of a diluent reservoir (30) containing a diluent (D) and a second fluid reservoir in the form of a lyse reservoir (32) containing lyse (L). The biological analysis system (10) further includes a plurality of fluid pumps including a first fluid pump in the form of a wash pump (40) configured to convey diluent (D) from the diluent reservoir (30) to various components of the biological system (10) as well as to perform various other functions described below, a second fluid pump in the form of a lyse pump (42) configured to convey lyse (L) from the lyse reservoir (32) to the WBC bath (12), and a third pump in the form of a waste pump (44) configured to convey one or more fluid media from the WBC and RBC baths (12, 14) (and/or from the CBC drip chamber) to a CBC waste receptacle (46). In the example shown, wash pump (40) is configured as a piston pump or a syringe pump, while lyse pump (42) and waste pump (44) are each configured as a metering pump. However, it will be appreciated that pumps (40, 42, 44) may each be configured in any manner suitable for performing the respective functions described herein.

To that end, the biological analysis system (10) further includes a plurality of fluid conduits and associated valves for selectively placing various components of the biological analysis system (10) into and out of fluid communication with each other. More particularly, the biological analysis system (10) includes a first fluid conduit in the form of a diluent supply line (50) extending from the diluent reservoir (30) to the wash pump (40) and a first valve in the form of a fill-wash-pump valve (52) positioned along the diluent supply line (50) between the diluent reservoir (30) and the wash pump (40) for selectively placing the diluent reservoir (30) and the wash pump (40) into and out of fluid communication with each other. The biological analysis system (10) also includes a second fluid conduit in the form of a common RBC/WBC input line (54) extending from a first T-junction (56) positioned along the diluent supply line (50) between the wash pump (40) and the fill-wash-pump valve (52) to a second T-junction (58). The biological analysis system (10) further includes a third fluid conduit in the form of an RBC input line (60) extending from the second T-junction (58) to the RBC bath (14), and a second valve in the form of a wash-to-RBC valve (62) positioned along the RBC input line (60) between the RBC bath (14) and the wash pump (40) for selectively placing the RBC bath (14) and the wash pump (40) into and out of fluid communication with each other. The biological analysis system (10) also includes a fourth fluid conduit in the form of a first WBC input line (64) extending from the second T-junction (58) to the WBC bath (12), and a third valve in the form of a wash-to-WBC valve (66) positioned along the first WBC input line (64) between the WBC bath (12) and the wash pump (40) for selectively placing the WBC bath (12) and the wash pump (40) into and out of fluid communication with each other.

The biological analysis system (10) further includes a fifth fluid conduit in the form of a lyse supply line (68) extending from the lyse reservoir (32) to the lyse pump (42) and a fourth valve in the form of a lyse valve (70) positioned along the lyse supply line (68) between the lyse reservoir (32) and the lyse pump (42) for selectively placing the lyse reservoir (32) and the lyse pump (42) into and out of fluid communication with each other. The biological analysis system (10) also includes a sixth fluid conduit in the form of a second WBC input line (72) extending from the lyse pump (42) to the WBC bath (12) for selectively placing the lyse pump (42) and the WBC bath (12) into and out of fluid communication with each other.

The biological analysis system (10) further includes seventh and eighth fluid conduits in the form of RBC and WBC drainage lines (74, 76) extending from the RBC bath (14) and from the WBC bath (16), respectively, to a third T-junction (78), and a ninth fluid conduit in the form of a common RBC/WBC drainage line (80) extending from the third T-junction (78) to the waste pump (44). The biological analysis system (10) also includes fifth and sixth valves in the form of drain-RBC and drain-WBC valves (82, 84) positioned along the RBC and WBC drainage lines (74, 76), respectively, for selectively placing the corresponding bath (12, 14) and the waste pump (44) into and out of fluid communication with each other.

Referring now to FIGS. 2A-2I, the biological analysis system (10) is configured to direct various fluid media to predetermined components of the biological analysis system (10) for facilitating analysis of the blood sample (B) or other biological sample. It will be appreciated that the illustrated open and/or closed states of the various valves of the biological analysis system (10) are for illustrative purposes only, and that the actual states of the valves may differ from those shown.

As shown in FIG. 2A, the wash pump (40) is configured to draw diluent (D) from the diluent reservoir (30) into the diluent supply line (50), such as when the fill-wash-pump valve (52) is in an open state, and to convey diluent (D) to the WBC and RBC baths (12, 14) via the common RBC/WBC input line (54) and respective RBC and WBC input lines (60, 64), such as when the fill-wash-pump valve (52) is in a closed state and the wash-to-RBC and the wash-to-WBC valves (62, 66) are each in an open state. In cases where one or both WBC and RBC baths (12, 14) may each initially contain a waste fluid (W), which may be residual from a previous procedure, the waste pump (44) may be configured to draw the waste fluid (W) and/or diluent (D) from the WBC and RBC baths (12, 14) into the corresponding RBC and WBC drainage lines (74, 76) and further into the common RBC/WBC drainage line (80), such as when the drain-RBC and drain-WBC valves (82, 84) are each in an open state, for expulsion into the waste receptacle (46). In this manner, the wash pump (40) and the waste pump (44) may be configured to cooperate with each other to flush the waste fluids (W) out of the WBC and RBC baths (12, 14) and to clean and empty the WBC and RBC baths (12, 14).

As shown in FIG. 2B, the wash pump (40) is also configured to convey diluent (D) to the empty WBC bath (12) via the common RBC/WBC input line (54) and first WBC input line (64), such as when the fill-wash-pump valve (52) is in the closed state, the wash-to-WBC valve (66) is in the open state, and the wash-to-RBC valve (62) is in a closed state. For example, the wash pump (40) may be configured to deliver a predetermined amount of diluent (D) to the WBC bath (12), such as about 500 μL to about 1000 μL, or about 800 μL of diluent (D).

As shown in FIG. 2C, the probe (16) is configured to dispense blood sample (B) into the WBC bath (12) for mixing with the diluent (D) contained therein, such as when the wash-to-WBC valve (66) is in a closed state. For example, the probe (16) may be configured to deliver a predetermined amount of blood sample (B) to the WBC bath (12), such as about 5 μL to about 25 μL, about 10 μL to about 15 μL, or about 12.4 μL of blood sample (B). In this regard, the probe (16) may be configured to aspirate blood sample (B) from a specimen (not shown) at a home or resting position and navigate along a path from the home position to the WBC bath (12) for dispensing blood sample (B) into the WBC bath (12). In some embodiments, the path may not include the RBC bath (14). For example, the probe (16) may be configured to return to the home position from the WBC bath (12) without reaching the RBC bath (14).

As shown in FIG. 2D, the wash pump (40) is further configured to convey additional diluent (D) to the WBC bath (12) for mixing with the blood sample (B) and diluent (D) already contained therein, via the common RBC/WBC input line (54) and first WBC input line (64), such as when the fill-wash-pump valve (52) is in the closed state, the wash-to-WBC valve (66) is in the open state, and the wash-to-RBC valve (62) is in the closed state. For example, the wash pump (40) may be configured to deliver a predetermined amount of additional diluent (D) to the WBC bath (12), such as about 500 μL to about 1000 μL, or about 800 μL of additional diluent (D). In some embodiments, the wash pump (40) may be configured to deliver the additional diluent (D) tangentially relative to the blood sample (B) and diluent (D) already contained within the WBC bath (12) to promote mixing of the contents of the WBC bath (12) (e.g., the blood sample (B) and both deliveries of diluent (D)) to a homogeneous state to define a predilute solution (P).

As shown in FIG. 2E, the wash pump (40) is also configured to draw at least the diluent (D) contained within the common RBC/WBC input line (54) and the first WBC input line (64) in an upstream direction and thereby aspirate an extracted portion (E) of the predilute solution (P) from the WBC bath (12) into the first WBC input line (64) and the common RBC/WBC input line (54), such as when the fill-wash-pump valve (52) is in the closed state, the wash-to-WBC valve (66) is in the open state, and the wash-to-RBC valve (62) is in the closed state. For example, the wash pump (40) may be configured to draw a predetermined amount of predilute solution (P) from the WBC bath (12), such as about 200 μL to about 1000 μL, about 400 μL to about 800 μL, or about 600 μL of predilute solution (P), to define the extracted portion (E). In some embodiments, an upstream edge of the extracted portion (E) may be in contact with and diluted by the diluent (D) within the common RBC/WBC input line (54) and/or the first WBC input line (64) and may thus define a corrupted region (C) of the extracted portion (E). For example, the corrupted region (C) may not be homogeneous (e.g., composed almost completely of diluent instead of a homogenous mixture of a blood sample and diluent) and/or may not be representative of the predilute solution (P) contained within the WBC bath (12). Thus, the wash pump (40) may be configured to draw the corrupted region (C) substantially upstream of the second T-junction (58) such that the corrupted region (C) is entirely within the common RBC/WBC input line (54), and such that at least a portion of an uncorrupted region of the extracted portion (E) (e.g., which is homogeneous and representative of the predilute solution (P) contained within the WBC bath (12)) is drawn upstream of the second T-junction (58) into the common RBC/WBC input line (54) to define a transfer portion (T) of the predilute solution (P). For example, the wash pump (40) may be configured to draw a predetermined amount of the uncorrupted region of the extracted portion (E) into the common RBC/WBC input line (54), such as about 10 μL to about 100 μL, or about 60 μL of the uncorrupted region of the extracted portion (E), to define the transfer portion (T) of the predilute solution (P).

As shown in FIG. 2F, the wash pump (40) is further configured to push at least the diluent (D) contained within the common RBC/WBC input line (54) in a downstream direction and thereby convey the transfer portion (T) of the predilute solution (P) from the common RBC/WBC input line (54) into the RBC input line (60) as well as convey at least a portion of diluent (D) contained within the RBC input line (60) into the empty RBC bath (14), such as when the fill-wash-pump valve (52) is in the closed state, the wash-to-WBC valve (66) is in the closed state, and the wash-to-RBC valve (62) is in the open state. For example, the wash pump (40) may be configured to deliver a predetermined amount of diluent (D) to the RBC bath (14) substantially equal to the predetermined amount of the predilute solution (P) defining the transfer portion (T) that is delivered to the RBC input line (60), such as about 10 μL to about 100 μL, or about 60 μL of diluent (D).

As shown in FIG. 2G, the lyse pump (42) is configured to draw lyse (L) from the lyse reservoir (32) into the lyse supply line (68), such as when the lyse valve (70) is in an open state, and to convey lyse (L) to the WBC bath (12) for mixing with the portion of the predilute solution (P) remaining therein, via the second WBC input line (72). For example, the lyse pump (42) may be configured to deliver a predetermined amount of lyse (L) to the WBC bath (12), such as about 250 μL to about 750 μL, about 400 μL to about 500 μL, or about 453 μL of lyse (L). In one example, lyse (L) is utilized to destroy red blood cells in the WBC bath (12), leaving white blood cells (WBC) for subsequent analysis (e.g., via a CBC drip chamber).

As shown in FIG. 2H, the wash pump (40) is further configured to convey additional diluent (D) to the WBC bath (12) for mixing with the lyse (L) and the portion of the predilute solution (P) already contained therein, via the common RBC/WBC input line (54) and first WBC input line (64), such as when the fill-wash-pump valve (52) is in the closed state, the wash-to-WBC valve (66) is in the open state, and the wash-to-RBC valve (62) is in the closed state. For example, the wash pump (40) may be configured to deliver a predetermined amount of additional diluent (D) to the WBC bath (12), such as about 1,000 μL to about 2,000 μL, about 1,500 μL to about 1,800 μL, or about 1,600 μL of additional diluent (D). In some embodiments, the wash pump (40) may be configured to deliver the additional diluent (D) tangentially relative to the lyse (L) and predilute solution (P) already contained within the WBC bath (12) to promote mixing of the contents of the WBC bath (12) (e.g., the lyse (L), predilute solution (P), and additional diluent (D)) to a homogeneous state to define a final WBC solution (FW). In some embodiments, the final WBC solution (FW) may have a volume of about 3,005.5 μL, which may include about 11.9 μL of blood sample (B), about 2,540.6 μL of diluent (D), and about 453 μL of lyse. In any event, the hemoglobin transducer (20) of the WBC bath (12) is configured to measure an amount of hemoglobin present in the final WBC solution (FW). For example, the hemoglobin transducer (20) may be configured to measure the amount of hemoglobin present in the final WBC solution (FW) upon completion of a hemoglobin incubation period, which may begin at the start of the delivery of lyse (L) into the WBC bath (12). In some embodiments, the biological analysis system (10) may be configured to initiate white blood cell count flow priming and/or data acquisition from the final WBC solution (FW) (e.g., using the CBC drip chamber) upon completion of a WBC incubation period, such as about 9.5 s, which may also begin at the start of the delivery of lyse (L) into the WBC bath (12). In one example, a lyse (L) is used in WBC bath (12) to eliminate red blood cells (RBC), which will expose hemoglobin contained within the RBC for analysis via the hemoglobin transducer (20).

As shown in FIG. 2I, the wash pump (40) is also configured to convey additional diluent (D) as well as the transport portion (T) of the predilute solution (P) contained within the RBC input line (60) to the RBC bath (14), via the common RBC/WBC input line (54) and RBC input line (60), such as when the fill-wash-pump valve (52) is in the closed state, the wash-to-WBC valve (66) is in the closed state, and the wash-to-RBC valve (62) is in the open state. For example, the wash pump (40) may be configured to deliver a predetermined amount of additional diluent (D) to the RBC bath (14), such as about 2,000 μL to about 3,000 μL, or about 2,800 μL of additional diluent (D). In some embodiments, the wash pump (40) may be configured to deliver the additional diluent (D) and/or the transport portion (T) of the predilute solution (P) tangentially relative to the diluent (D) already contained within the RBC bath (14) to promote mixing of the contents of the RBC bath (14) (e.g., the transport portion (T) of the predilute solution (P) and both deliveries of diluent (D)) to a homogeneous state to define a final RBC solution (FR). In some embodiments, the final RBC solution (FR) may have a volume of about 2,860 μL, which may include about 0.5 μL of blood sample (B) and about 2,859.5 μL of diluent (D). In addition, or alternatively, the final RBC solution (FR) may have a diluent-to-blood ratio of about 6,251. In some embodiments, the biological analysis system (10) may be configured to initiate red blood cell/platelet count flow priming and/or data acquisition from the final RBC solution (FR) (e.g., using the CBC drip chamber) upon completion of mixing of the final RBC solution (FR) to homogeneity.

While not shown, the biological analysis system (10) may further include various other suitable components for facilitating analysis of the blood sample (B) or other biological sample. For example, the biological analysis system (10) may further include a sweep flow tank (not shown) fluidly coupled to the first T-junction (56) and/or to the RBC bath (14) via corresponding conduits equipped with respective valves for selectively conveying fluid media therebetween. In addition, or alternatively, the biological analysis system (10) may include a CBC gas pump (not shown) fluidly coupled to the CBC drip chamber via one or more corresponding conduits equipped with one or more respective valves for selectively conveying fluid media therebetween. In some embodiments, the biological analysis system (10) may include at least one heater (not shown) configured to heat diluent (D) (e.g., within the common RBC/WBC input line (54)) and/or lyse (L) (e.g., within the second WBC input line (72)).

It will be appreciated that, by utilizing the wash pump (40) to aspirate the extracted portion (E) of the predilute solution (P) from the WBC bath (12) and/or by utilizing the wash pump (40) to deliver the transfer portion (T) of the extracted portion (E) of the predilute solution (P) to the RBC bath (14), the biological analysis system (10) may have a decreased reliance on probe (16) for facilitating analysis of the blood sample (B) within the RBC bath (14), at least by comparison to systems which rely on probe (16) to aspirate a portion of the predilute solution (P) from the WBC bath (12) and/or to dispense the aspirated portion of the predilute solution (P) into the RBC bath (14). Thus, probe (16) may be configured to perform various other tasks while the wash pump (40) aspirates the extracted portion (E) of the predilute solution (P) from the WBC bath (12) and/or while the wash pump (40) delivers the transfer portion (T) of the extracted portion (E) of the predilute solution (P) to the RBC bath (14). For example, probe (16) may be configured to facilitate analysis of various other parameters, such as flow imaging RBC, WBC, and PLT, while the wash pump (40) facilitates delivery of the transfer portion (T) to the RBC bath (14).

It will also be appreciated that, by excluding the RBC bath (14) from the path of the probe (16), the biological analysis system (10) may reduce the complexity and/or footprint of the path of the probe (16), at least by comparison to systems which include the RBC bath (14) along the path of the probe (16), and may thereby enable the biological analysis system (10) to have a reduced overall size, at least by comparison to such systems.

Though the embodiments herein have described a WBC bath (12) and RBC bath (14) as part of a shielded CBC box (18) linked to a CBC drip chamber, other embodiments are contemplated utilizing the pump fluid transfer techniques contemplated herein. For instance, a WBC bath (12) and RBC bath (14) can be used in a blood analysis system utilizing flow imaging where, for instance, a WBC bath (12) and RBC bath (14) are linked to a flowcell such that the contents of each are conveyed through a flowcell for imaging by a high speed, high resolution camera. The principle of using a pump (40) to facilitate fluid transfer between chambers or baths of an analysis system to reduce reliance on a probe (16) can broadly be used to reduce systems load and increase throughput in a variety of settings.

Note, other embodiments (e.g., systems and associated methods) utilize a wash pump/syringe pump fluid transfer system as contemplated herein. For instance, a probe (16) can initially deliver a diluent and a blood sample to an RBC bath (14), where the sample mixture/predilute solution is then conveyed to a WBC bath (12) via pump (40). Other embodiments can utilize more than two baths (12, 14), where pump (40) is used to convey a blood sample solution (e.g., a mixture of blood and diluent) between one or more of the more than two baths. For instance, rather than incorporating an HGB transducer (20) with WBC bath (12) for the purposes of hemoglobin measurements, a third bath can be utilized for this purpose.

### B. FIRST EXEMPLARY METHOD EMBODIMENTS OF ANALYZING A BIOLOGICAL SAMPLE

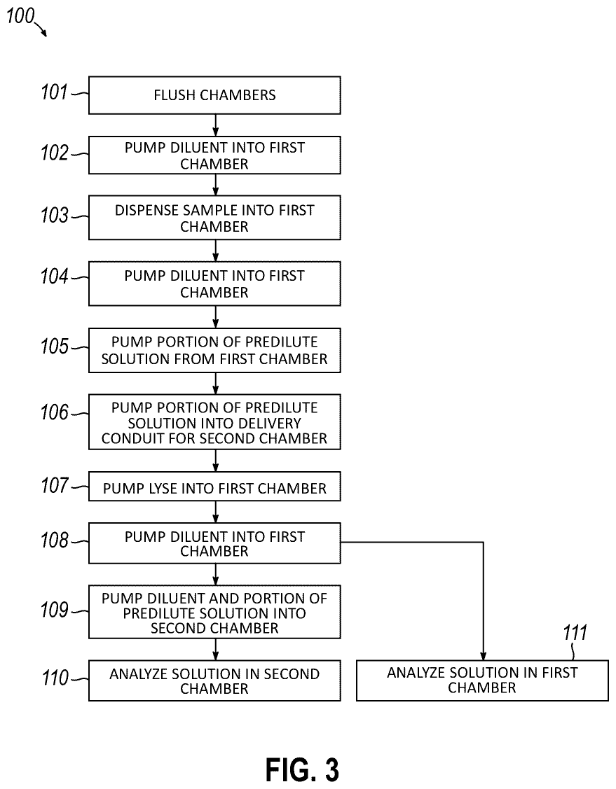

FIG. 3 shows an exemplary method (100) of analyzing a biological sample, such as the blood sample (B). While the method (100) is described as being performed using the biological analysis system (10) described above, it will be appreciated that the method (100) may be performed using any suitable biological analysis system.

The method (100) begins with step (101), at which first and second fluid analysis chambers, such as the WBC and RBC baths (12, 14), are flushed and thereby cleaned and/or emptied of any waste fluids (W) contained therein. In some embodiments, step (101) may be performed by drawing diluent (D) from the diluent reservoir (30) into the diluent supply line (50) and conveying diluent (D) to the WBC and RBC baths (12, 14) via wash pump (40), and/or by expelling the waste fluids (W) and/or diluent (D) from the WBC and RBC baths (12, 14) via the waste pump (44) as described above in connection with FIG. 2A. It will be appreciated that at the conclusion of step (101), each of the common RBC/WBC input line (54), the RBC input line (60), and the first WBC input line (64) will be substantially filled with clean diluent (D) while each of the WBC and RBC baths (12, 14) will be substantially empty.

The method (100) proceeds from step (101) to step (102), at which diluent (D) is pumped or otherwise conveyed into the first fluid analysis chamber, such as the HGB/WBC bath (12). In some embodiments, step (102) may be performed by delivering a predetermined amount of diluent (D) to the WBC bath (12), such as about 2 mL of diluent (D), via the wash pump (40) as described above in connection with FIG. 2B.

The method (100) proceeds from step (102) to step (103), at which blood sample (B) is dispensed into the first fluid analysis chamber, such as the HGB/WBC bath (12). In some embodiments, step (103) may be performed by delivering a predetermined amount of blood sample (B) to the WBC bath (12), such as about 10 μL of blood sample (B), via the probe (16) for mixing with the diluent (D) contained therein as described above in connection with FIG. 2C. It will be appreciated that, prior to step (103), the method (100) may include aspirating blood sample (B) from a specimen (not shown) via the probe (16) at a home position and then navigating the probe (16) along a path from the home position to the WBC bath (12) for dispensing blood sample (B) into the WBC bath (12). The method (100) may also include returning the probe (16) to the home position from the WBC bath (12) without reaching the RBC bath (14).

The method (100) proceeds from step (103) to step (104), at which additional diluent (D) is pumped or otherwise conveyed into the first fluid analysis chamber, such as the WBC bath (12). In some embodiments, step (104) may be performed by delivering a predetermined amount of additional diluent (D) to the WBC bath (12), such as about 800 μL of additional diluent (D), tangentially relative to the blood sample (B) and diluent (D) already contained within the WBC bath (12) via the wash pump (40) to promote mixing of the contents of the WBC bath (12) to a homogeneous state to define the predilute solution (P) as described above in connection with FIG. 2D.

The method (100) proceeds from step (104) to step (105), at which the extracted portion (E) of the predilute solution (P) is pumped or otherwise aspirated from the first fluid analysis chamber, such as the HGB/WBC bath (12). In some embodiments, step (105) may be performed by drawing a predetermined amount of predilute solution (P) from the HGB/WBC bath (12), such as about 200 μL of predilute solution (P), to define the extracted portion (E) via the wash pump (40), and by drawing the corrupted region (C) of the extracted portion (E) substantially upstream of the second T-junction (58) such that a predetermined amount of an uncorrupted region of the extracted portion (E), such as about 60 μL of the uncorrupted region of the extracted portion (E), is drawn upstream of the second T-junction (58) into the common RBC/WBC input line (54) to define a transfer portion (T) of the predilute solution (P) as described above in connection with FIG. 2E. Thus, step (105) may be performed without utilizing probe (16) to aspirate the transfer portion (T) of predilute solution (P) from the WBC bath (16), thereby freeing up probe (16) to perform other tasks contemporaneously with performance of step (105).

The method (100) proceeds from step (105) to step (106), at which the transfer portion (T) of the predilute solution (P) is pumped or otherwise conveyed into a delivery conduit for the second fluid analysis chamber, such as the RBC input line (60). In some embodiments, step (106) may be performed by delivering the transfer portion (T) to the RBC input line (60) via the wash pump (40) as described above in connection with FIG. 2F. It will be appreciated that a predetermined amount of diluent (D) contained within the RBC input line (60), such as about 60 μL of diluent (D), may be delivered into the empty RBC bath (14) via the wash pump (40) during performance of step (106).

The method (100) proceeds from step (106) to step (107), at which lyse (L) is pumped or otherwise conveyed into the first fluid analysis chamber, such as the WBC bath (12). In some embodiments, step (107) may be performed by delivering a predetermined amount of lyse (L) to the WBC bath (12), such as about 288 μL of lyse (L), for mixing with the portion of the predilute solution (P) remaining therein via the lyse pump (42) as described above in connection with FIG. 2G.

The method (100) proceeds from step (107) to step (108), at which additional diluent (D) is pumped or otherwise conveyed into the first fluid analysis chamber, such as the WBC bath (12). In some embodiments, step (108) may be performed by delivering a predetermined amount of additional diluent (D) to the WBC bath (12), such as about 1,600 μL of additional diluent (D), tangentially relative to the lyse (L) and predilute solution (P) already contained within the WBC bath (12) via the wash pump (40) to promote mixing of the contents of the WBC bath (12) to a homogeneous state to define the final WBC solution (FW) as described above in connection with FIG. 2H.

The method (100) proceeds from step (108) to step (109), at which additional diluent (D) and the transfer portion (T) of predilute solution (P) are pumped or otherwise conveyed into the second fluid analysis chamber, such as the RBC bath (14). In some embodiments, step (109) may be performed by delivering the transfer portion (T) of the predilute solution (P) and a predetermined amount of additional diluent (D) to the RBC bath (14), such as about 2,800 μL of additional diluent (D), tangentially relative to the diluent (D) already contained within the RBC bath (14) via the wash pump (40) to promote mixing of the contents of the RBC bath (14) to a homogeneous state to define the final RBC solution (FR) as described above in connection with FIG. 2I. Thus, step (109) may be performed without utilizing probe (16) to deliver the transfer portion (T) of predilute solution (P) to the RBC bath (14), thereby freeing up probe (16) to perform other tasks contemporaneously with performance of step (109).

The method (100) proceeds from step (109) to step (110), at which the final RBC solution (FR) in the second fluid analysis chamber, such as the RBC bath (14), is analyzed. In some embodiments, step (110) may be performed immediately after completion of step (109). In any event, step (110) may include initiating red blood cell/platelet count flow priming and/or data acquisition from the final RBC solution (FR).

In the example shown, the method (100) also proceeds from step (108) to step (111), at which the final WBC solution (FW) in the first fluid analysis chamber, such as the WBC bath (12), is analyzed. In some embodiments, step (111) may be performed upon completion of one or more incubation periods which may begin at the start of the delivery of lyse (L) into the WBC bath (12) during performance of step (107). For example, step (111) may include measuring an amount of hemoglobin present in the final WBC solution (FW), such as via the hemoglobin transducer (20) of the WBC bath (12), upon completion of the hemoglobin incubation period. In addition, or alternatively, step (111) may include initiating white blood cell count flow priming and/or data acquisition from the final WBC solution (FW) upon completion of the WBC incubation period, such as about 12-14 s from the start of the delivery of lyse (L) into the WBC bath (12). It will be appreciated that step (111) may be performed in parallel with one or more of steps (109, 110).

In some embodiments, after steps (110, 111) are completed, the method (100) may return to step (101) in which the first and second fluid analysis chambers, such as the WBC and RBC baths (12, 14), are flushed and thereby cleaned and/or emptied of any waste fluids (W) (e.g., the final WBC and RBC solutions (FW, FR) from the previous cycle) contained therein to perform another cycle.

### C. SECOND EXEMPLARY BIOLOGICAL ANALYSIS SYSTEM EMBODIMENTS

FIG. 4 shows another exemplary biological analysis system (210) that includes, among other components, a pair of fluid analysis chambers including a first fluid analysis chamber in the form of a first bath (212) and a second fluid analysis chamber in the form of a second bath (214). As shown in FIG. 4, first bath (212) is a white blood cell (WBC) or hemoglobin (HGB) bath and second bath (214) is a red blood cell (RBC) bath. In the example shown the WBC bath (212) is open for permitting a sample probe (216) of the system (210) to selectively access the WBC bath (212), such as to aspirate fluid therefrom and/or dispense fluid thereto. While not shown, the WBC and RBC baths (212, 214) of the present embodiment may be housed within a shielded complete blood count (CBC) box similar to CBC box (18).

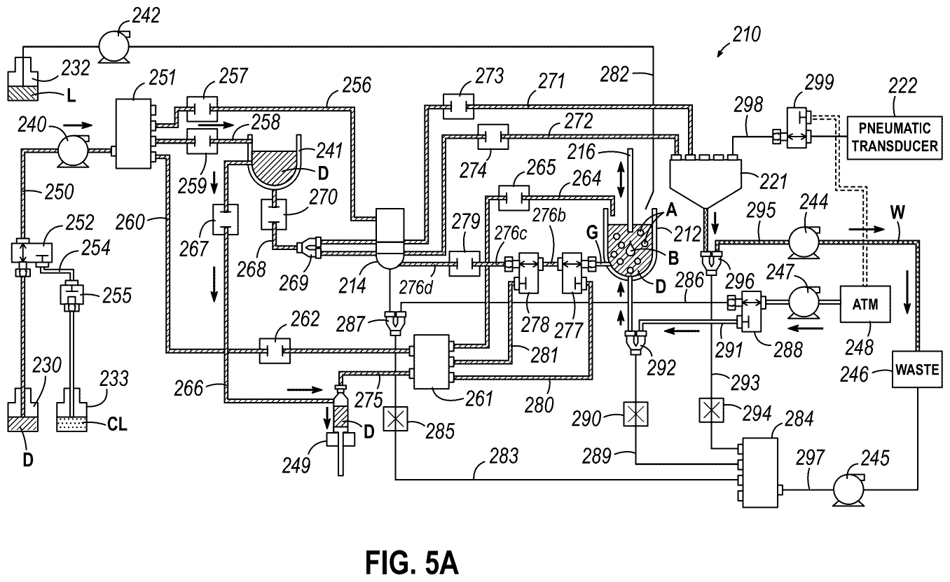

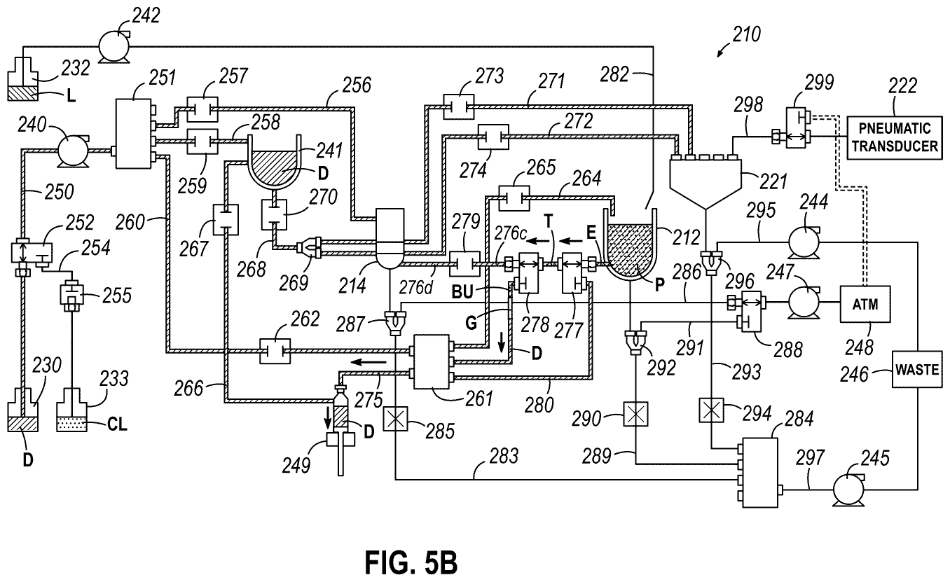

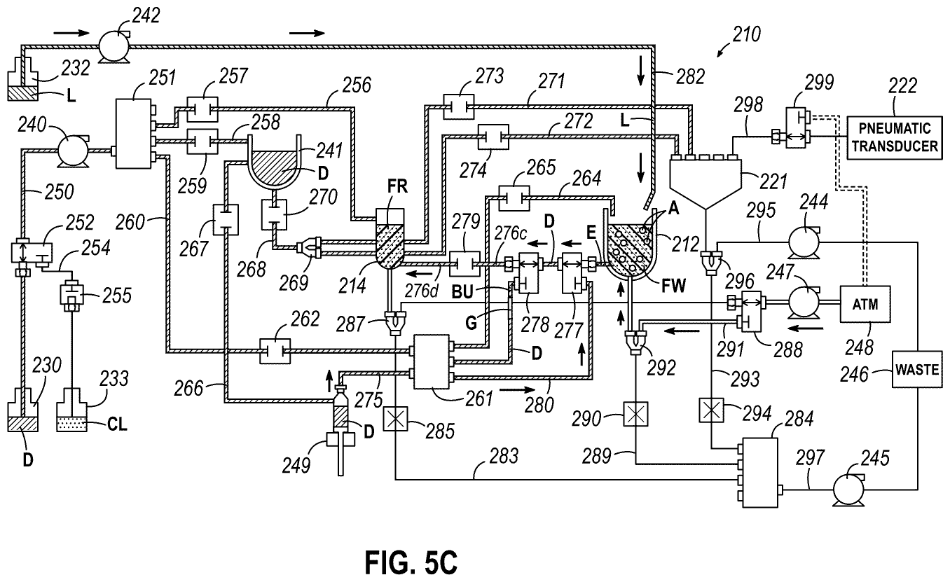

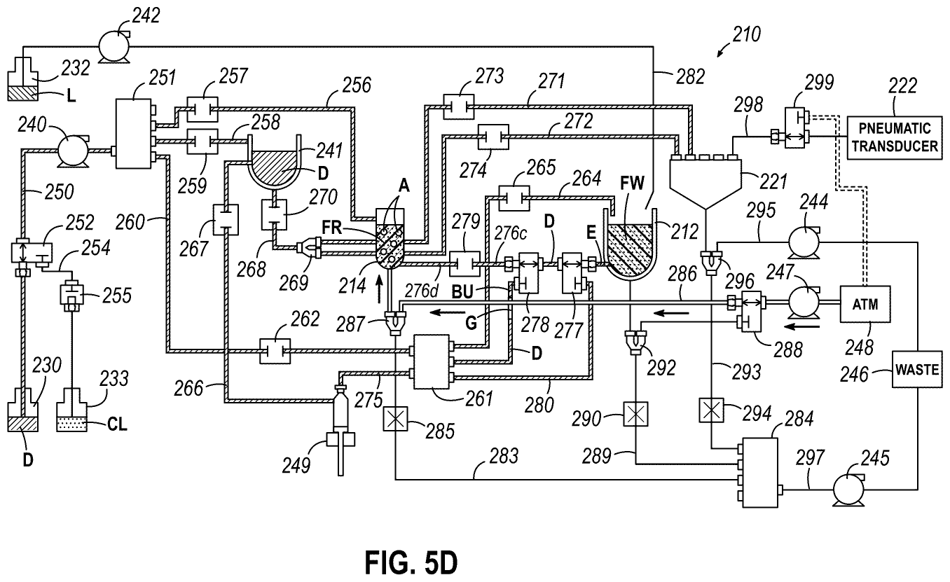

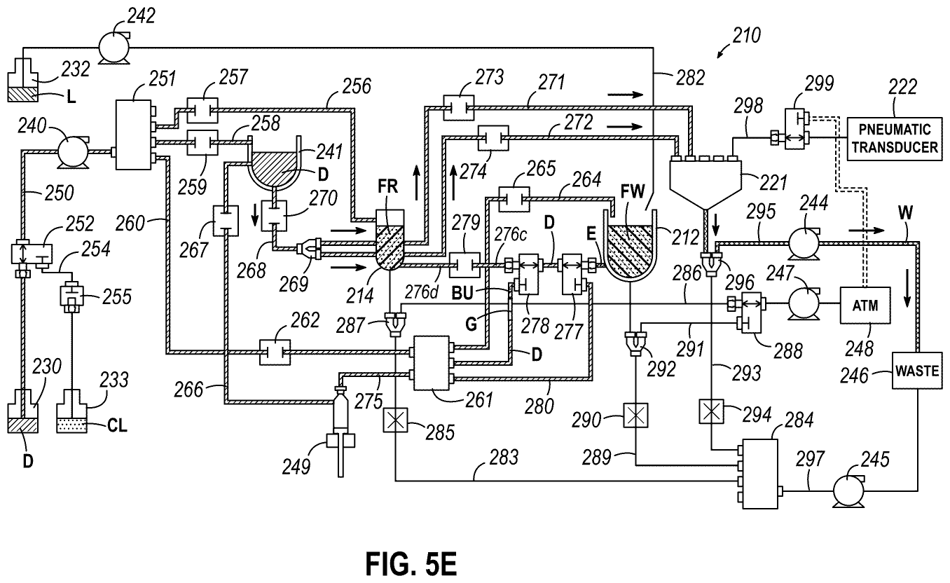

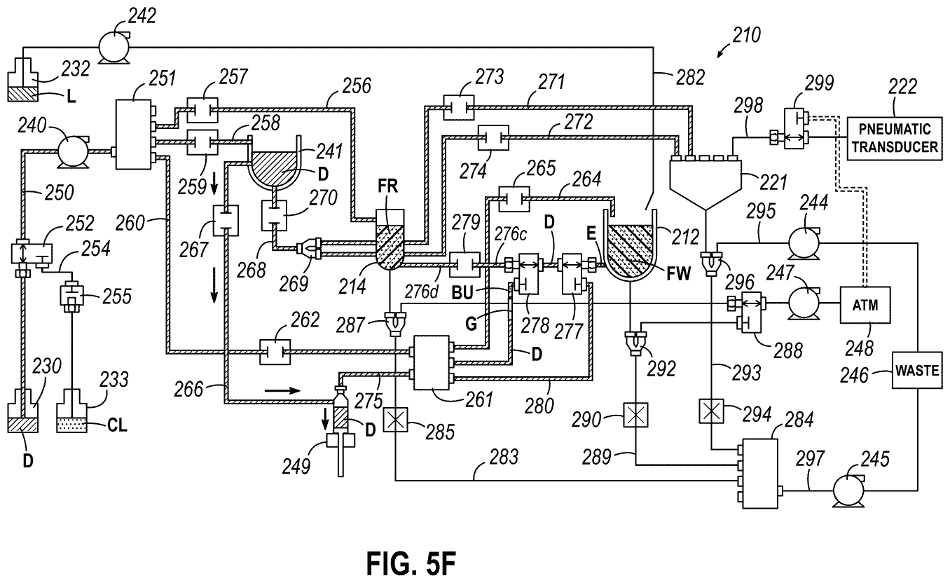

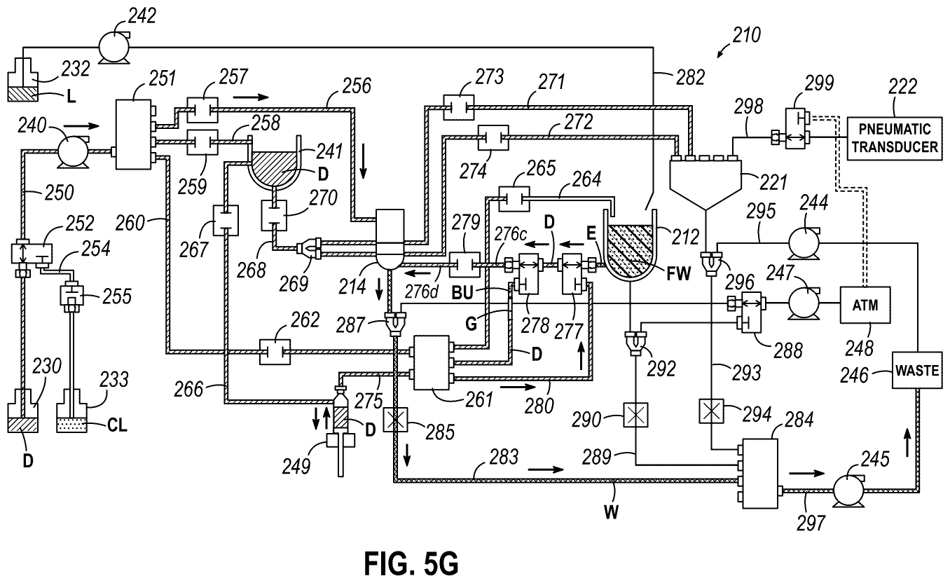

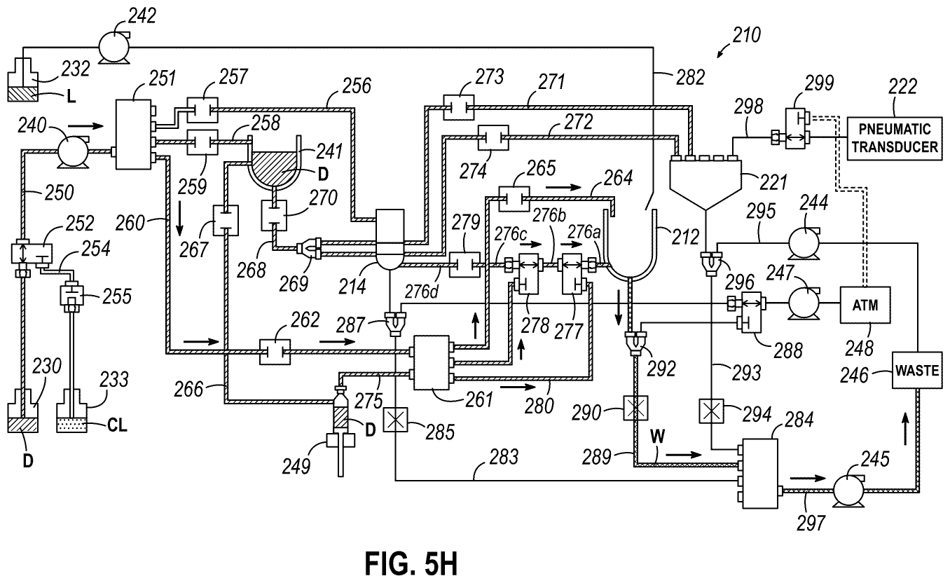

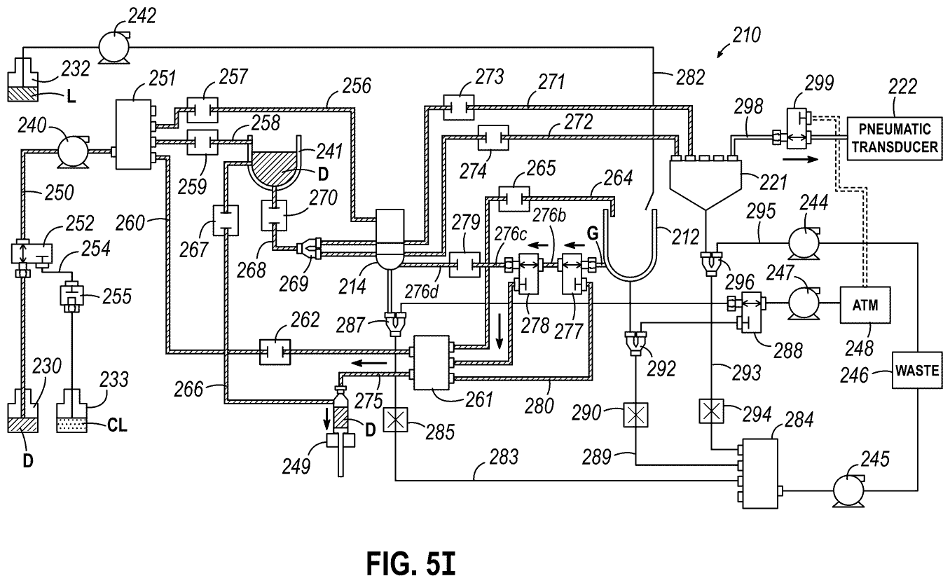

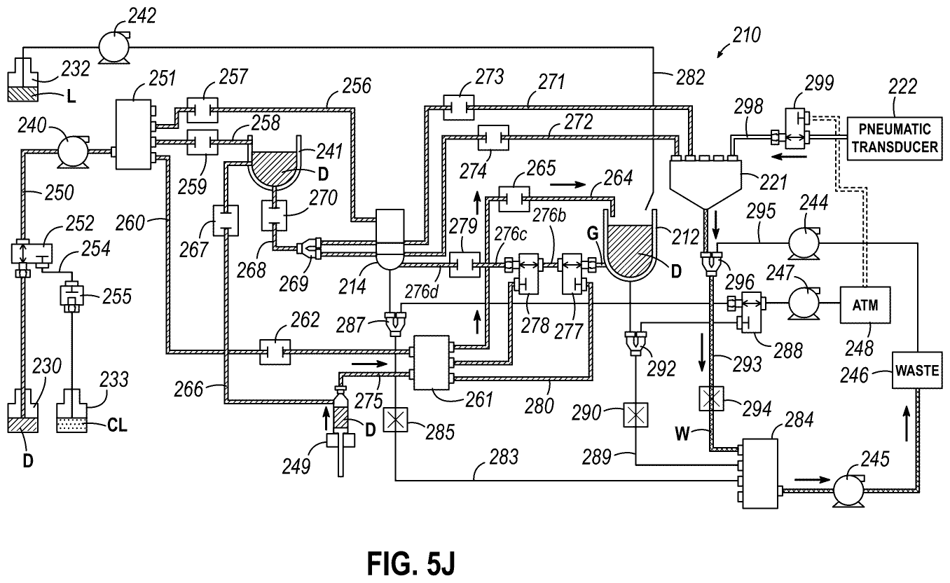

The biological analysis system (210) is configured to analyze a biological sample. In some embodiments, the biological analysis system (210) is configured to analyze a blood sample (B) (FIG. 5A), such that the biological analysis system (210) may be referred to as a blood analysis system. While not shown, the WBC bath (212) of the present embodiment may include a hemoglobin transducer similar to hemoglobin transducer (20) configured to measure an amount of hemoglobin present in a fluid medium contained within the WBC bath (212). For example, the hemoglobin transducer may include a light source (e.g., a filtered light source) and an optical sensor configured to receive optical signals emitted from the light source through the fluid medium contained within the WBC bath (212). In some embodiments, the WBC and RBC baths (212, 214) may each be fluidly coupled to a CBC drip chamber (221) housed within the shielded CBC box via corresponding input and output conduits equipped with respective valves for selectively conveying fluid media from one of the WBC or RBC baths (212, 214) to the CBC drip chamber (221) and/or for returning such fluid media from the CBC drip chamber (221) to the WBC or RBC bath (212, 214). The CBC drip chamber (221) may be configured to measure a complete blood count of the fluid media received from each bath (212, 214). In other embodiments, only one of the WBC or RBC baths (212, 214) (e.g., only the RBC bath (214)), may be fluidly coupled to the CBC drip chamber (221). In the example shown, the CBC drip chamber (221) is also fluidly coupled to a pneumatic transducer (222). While analysis (e.g., impedance based counting, optical techniques, and/or imaging) of blood is shown and described herein, the biological analysis system (210) may analyze (and optionally image) a variety of fluids including, but not limited to, other bodily fluids such as synovial fluid, urine, bone marrow, etc.

As shown in FIG. 4, the biological analysis system (210) also includes a plurality of fluid reservoirs including a first fluid reservoir in the form of a diluent reservoir (230) containing a diluent (D), a second fluid reservoir in the form of a lyse reservoir (232) containing lyse (L), and a third fluid reservoir in the form of a cleaner reservoir (233) containing a cleaner (CL). The biological analysis system (210) further includes a plurality of fluid pumps including a first fluid pump in the form of a wash pump (240) configured to convey diluent (D) from the diluent reservoir (230) and/or to convey cleaner (CL) from the cleaner reservoir (233) to various components of the biological system (210) including a sweep flow tank (241), a second fluid pump in the form of a lyse pump (242) configured to convey lyse (L) from the lyse reservoir (232) to the WBC bath (212), a third pump in the form of vacuum pump (244) configured to regulate the desired count vacuum via pneumatic transducer (222), a fourth pump in the form of waste pump (245) configured to convey one or more fluid media from the WBC and RBC baths (212, 214) (and/or from the CBC drip chamber (221)) to a waste receptacle (246), a fifth pump in the form of a mix pump (247) configured to deliver mixing bubbles of air (A) from atmosphere (248) to the WBC and RBC baths (212, 214), and a sixth pump in the form of a diluent pump (249) configured to convey diluent (D) from the sweep flow tank (241) to the WBC and RBC baths (212, 214) as well as to perform various other functions described below. In the example shown, the diluent pump (249) is configured as a piston pump or a syringe pump, while the wash pump (240), lyse pump (242), vacuum pump (244), waste pump (245), and mix pump (247) are each configured as a peristaltic pump. However, it will be appreciated that the pumps (240, 242, 244, 245, 247, 249) may each be configured in any manner suitable for performing the respective functions described herein.

To that end, the biological analysis system (210) further includes a plurality of fluid conduits and associated valves for selectively placing various components of the biological analysis system (210) into and out of fluid communication with each other. More particularly, the biological analysis system (210) includes a fluid conduit in the form of a diluent supply line (250) extending from the diluent reservoir (230) through the wash pump (240) to a first multi-flow unit (251), and a valve in the form of a diluent/cleaner valve (252) positioned along the diluent supply line (250) between the diluent reservoir (230) and the wash pump (240) for selectively placing the diluent reservoir (230) and the first multi-flow unit (251) into and out of fluid communication with each other. The biological analysis system (210) also includes a fluid conduit in the form of a cleaner supply line (254) extending from the cleaner reservoir (233) to the diluent/cleaner valve (252), and a valve in the form of a cleaner valve (255) positioned along the cleaner supply line (254) between the cleaner reservoir (233) and the diluent/cleaner valve (252) for cooperating with the diluent/cleaner valve (252) to selectively place the cleaner reservoir (233) and the first multi-flow unit (251) into and out of fluid communication with each other.

The biological analysis system (210) also includes a fluid conduit in the form of an RBC input line (256) extending from the first multi-flow unit (251) to the RBC bath (214), and a valve in the form of a wash-to-RBC valve (257) positioned along the RBC input line (256) between the first multi-flow unit (251) and the RBC bath (214) for selectively placing the RBC bath (214) and the first multi-flow unit (251) into and out of fluid communication with each other. The biological analysis system (210) also includes a fluid conduit in the form of a sweep flow input line (258) extending from the first multi-flow unit (251) to the sweep flow tank (241), and a valve in the form of a wash-to-sweep flow valve (259) positioned along the sweep flow input line (258) between the first multi-flow unit (251) and the sweep flow tank (241) for selectively placing the sweep flow tank (241) and the first multi-flow unit (251) into and out of fluid communication with each other. The biological analysis system (210) further includes a fluid conduit in the form of a second multi-flow unit input line (260) extending from the first multi-flow unit (251) to a second multi-flow unit (261), and a valve in the form of a multi-flow input valve (262) positioned along the second multi-flow unit input line (260) between the first and second multi-flow units (251, 261) for selectively placing the first and second multi-flow units (251, 261) into and out of fluid communication with each other. The biological analysis system (210) also includes a fluid conduit in the form of a WBC input line (264) extending from the second multi-flow unit (261) to the WBC bath (212), and a valve in the form of a wash-to-WBC valve (265) positioned along the WBC input line (264) between the second multi-flow unit (261) and the WBC bath (212) for selectively placing the WBC bath (212) and the second multi-flow unit (261) into and out of fluid communication with each other.

The biological analysis system (210) further includes a fluid conduit in the form of a diluent input line (266) extending from the sweep flow tank (241) to the diluent pump (249), and a valve in the form of a diluent input valve (267) positioned along the diluent input line (266) between the sweep flow tank (241) and the diluent pump (249) for selectively placing the diluent pump (249) and the sweep flow tank (241) into and out of fluid communication with each other. The biological analysis system (210) also includes a fluid conduit in the form of a common sweep flow input line (268) extending from the sweep flow tank (241) to a first Y-junction (269), and a valve in the form of a sweep flow valve (270) positioned along the common sweep flow input line (268) between the sweep flow tank (241) and the first Y-junction (269) for selectively placing the first Y-junction (269) and the sweep flow tank (241) into and out of fluid communication with each other. The biological analysis system (210) further includes fluid conduits in the form of sweep flow lines (271, 272) extending from the first Y-junction (269) to the CBC chamber (221), and valves in the form of sweep flow valves (273, 274) positioned along the respective sweep flow lines (271, 272) between the first Y-junction (269) and the CBC chamber (221) for selectively placing the CBC chamber (221) and the first Y-junction (269) into and out of fluid communication with each other.

The biological analysis system (210) also includes a fluid conduit in the form of a diluent input/output line (275) extending from the diluent pump (249) to the second multi-flow unit (261). The biological analysis system (210) further includes a fluid conduit in the form of a transfer line including a plurality of transfer line portions (276a, 276b, 276c, 276d) extending from the WBC bath (212) to the RBC bath (214), and a plurality of valves in the form of first, second, and third transfer line valves (277, 278, 279) positioned along the transfer line (276) between the WBC and RBC baths (212, 214) for selectively placing the plurality of transfer line portions (276a, 276b, 276c, 276d) into and out of fluid communication with each other. As shown, the first and second transfer line valves (277, 278) are each three-way valves. The second transfer line portion (276b) extending between the first and second transfer line valves (277, 278) may have a fixed, predetermined volume such that the second transfer line portion (276b) may be selectively and precisely filled with a fluid having the same predetermined volume. For example, the second transfer line portion (276b) may be constructed of a substantially rigid (e.g., non-expandable) tube. The biological analysis system (210) also includes fluid conduits in the form of a diluent push line (280) and a diluent push/pull line (281) extending from the second multi-flow unit (261) to respective transfer line valves (277, 278) such that transfer line valves (277, 278) may selectively place the respective diluent push line (280) or diluent push/pull line (281) into and out of fluid communication with corresponding transfer line portions (276a, 276b, 276c, 276d).

The biological analysis system (210) further includes a fluid conduit in the form of a lyse supply line (282) extending from the lyse reservoir (232) through the lyse pump (242) to the WBC bath (212).

The biological analysis system (210) further includes a fluid conduit in the form an RBC drainage line (283) extending from the RBC bath (214) to a third multi-flow unit (284), and a valve in the form of an RBC drain valve (285) positioned along the RBC drainage line (283) between the RBC bath (214) and the third multi-flow unit (284) for selectively placing the third multi-flow unit (284) and the RBC bath (214) into and out of fluid communication with each other. The biological analysis system (210) also includes a fluid conduit in the form of a mixing air line (286) extending from atmosphere (248) through the mix pump (247) to a second Y-junction (287) positioned along the RBC drainage line (283) between the RBC bath (214) and the RBC drain valve (285), and a valve in the form of a mix pump valve (288) positioned along the mixing air line (286) between the mix pump (247) and the RBC bath (214) for selectively placing the RBC bath (214) and the mix pump (247) into and out of fluid communication with each other. The biological analysis system (210) further includes a fluid conduit in the form of a WBC drainage line (289) extending from the WBC bath (212) to the third multi-flow unit (284), and a valve in the form of a WBC drain valve (290) positioned along the WBC drainage line (289) between the WBC bath (212) and the third multi-flow unit (284) for selectively placing the third multi-flow unit (284) and the WBC bath (212) into and out of fluid communication with each other. The biological analysis system (210) also includes a fluid conduit in the form of a mixing air line (291) extending from the mix pump valve (288) to a third Y-junction (292) positioned along the WBC drainage line (289) between the WBC bath (212) and the WBC drain valve (290), such that the mix pump valve (288) may selectively place the WBC bath (212) and the mix pump (247) into and out of fluid communication with each other.

The biological analysis system (210) also includes a fluid conduit in the form of a CBC drainage line (293) extending from the CBC chamber (221) to the third multi-flow unit (284), and a valve in the form of a CBC drain valve (294) positioned along the CBC drainage line (293) between the CBC chamber (221) and the third multi-flow unit (284) for selectively placing the third multi-flow unit (284) and the CBC chamber (221) into and out of fluid communication with each other. The biological analysis system (210) also includes a fluid conduit in the form of a waste line (295) extending from the waste receptacle (246) through the vacuum pump (244) to a fourth Y-junction (296) positioned along the CBC drainage line (293) between the CBC chamber (221) and the CBC drain valve (294). The biological analysis system (210) further includes a fluid conduit in the form of a waste line (297) extending from the waste receptacle (246) through the waste pump (245) to the third multi-flow unit (284).

The biological analysis system (210) further includes a fluid conduit in the form of a vacuum line (298) extending from the CBC chamber (221) to the pneumatic transducer (222), and a valve in the form of a vacuum line valve (299) positioned along the vacuum line (298) between the CBC chamber (221) and the pneumatic transducer (222) for selectively placing the pneumatic transducer (222) and the CBC chamber (221) into and out of fluid communication with each other. In some embodiments, the vacuum line valve (299) may also be configured to selectively place the CBC chamber (221) and atmosphere (248) into and out of fluid communication with each other, such as for venting the CBC chamber (221).

Referring now to FIGS. 5A-5J, the biological analysis system (210) is configured to direct various fluid media to predetermined components of the biological analysis system (210) for facilitating analysis of the blood sample (B) or other biological sample. It will be appreciated that the illustrated open and/or closed states of the various valves of the biological analysis system (210) are for illustrative purposes only, and that the actual states of the valves may differ from those shown.

As shown in FIG. 5A, the wash pump (240) is configured to draw diluent (D) from the diluent reservoir (230) into the diluent supply line (250), such as when the diluent/cleaner valve (252) is in a first open state (e.g., placing the diluent reservoir (230) and the first multi-flow unit (251) into fluid communication with each other), and to convey diluent (D) to the sweep flow tank (241) via the first multi-flow unit (251) and the sweep flow input line (258), such as when the wash-to-sweep flow valve (259) is in an open state (e.g., placing the sweep flow tank (241) and the first multi-flow unit (251) into fluid communication with each other).

As also shown in FIG. 5A, the diluent pump (249) is configured to draw diluent (D) from the sweep flow tank (241) into the diluent input line (266) and further into the diluent pump (249) such that the diluent pump (249) may be charged with diluent (D), such as when the diluent input valve (267) is in an open state (e.g., placing the diluent pump (249) and the sweep flow tank (241) into fluid communication with each other). In some embodiments, the diluent pump (249) may be configured to be charged with a first predetermined volume of diluent (D) via the diluent input line (266), such as the difference between the volume of the RBC bath (214) and the volume of predilute solution (P) that is desired for subsequent extraction from the WBC bath (212) to define the extracted portion (E), such as about 200 μL to about 250 μL of predilute solution (P) (e.g., about 200 μL or about 250 μL of predilute solution (P)), as described in greater detail below.

As further shown in FIG. 5A, the probe (216) is configured to dispense blood sample (B) into the WBC bath (212) for mixing with the diluent (D) initially contained therein. For example, the probe (216) may be configured to deliver a predetermined amount of blood sample (B) to the WBC bath (212), such as about 10 μL to about 16 μL of blood sample (B) (e.g., about 10 μL, about 12 μL, about 14 μL, or about 16 μL of blood sample (B)). In this regard, the probe (216) may be configured to aspirate blood sample (B) from a specimen (not shown) at a home or resting position and navigate along a path from the home position to the WBC bath (212) for dispensing blood sample (B) into the WBC bath (212). In some embodiments, the path may not include the RBC bath (214). For example, the probe (216) may be configured to return to the home position from the WBC bath (212) without reaching the RBC bath (214).

As also shown in FIG. 5A, the mix pump (247) is configured to draw air (A) from atmosphere (248) and deliver mixing bubbles of air (A) to the WBC bath (212) via the mixing air line (291) and the WBC drainage line (289), such as when the mix pump valve (288) is in a first open state (e.g., placing the WBC bath (212) and the mix pump (247) into fluid communication with each other), to promote mixing of the contents of the WBC bath (212) (e.g., the blood sample (B) and diluent (D)) to a homogeneous state to define a predilute solution (P). As also shown in FIG. 5A, the waste pump (245) is configured to draw residual waste fluid (W) from the CBC chamber (221) into the CBC drainage line (293) and further into the waste line (295) to the waste receptacle (246).

As shown in FIG. 5B, the diluent pump (249) is configured to draw diluent (D) from the second transfer line portion (276b) into the diluent input/output line (275) via the diluent push/pull line (281) and the second multi-flow unit (261) and further into the diluent pump (249) such that the diluent pump (249) may be further charged with diluent (D). In some embodiments, the diluent pump (249) may be configured to be charged with a second predetermined volume of diluent (D) via the diluent input/output line (275). For example, the cumulative volume of diluent (D) with which the diluent pump (249) is configured to be charged via the diluent input line (266) and the diluent input/output line (275) may be selected for subsequently delivering a desired volume of diluent (D) to the RBC bath (214), such as about 2.804 mL to about 3.364 mL of diluent (D) (e.g., about 2.804 mL or about 3.364 mL of diluent (D)), as described in greater detail below.

As also shown in FIG. 5B, the diluent pump (249) is also configured to draw an air gap (G) from the first transfer line portion (276a) through the second transfer line portion (276a) into the diluent push/pull line (281) and to aspirate an extracted portion (E) of the predilute solution (P) from the WBC bath (212) into the first and second transfer line portions (276a, 276b) and the diluent push/pull line (281), such as when the first and second transfer line valves (277, 278) are each in a first open state (e.g., placing the diluent push/pull line (281) and the first and second transfer line portions (276a, 276b) into fluid communication with each other). For example, the diluent pump (249) may be configured to draw a predetermined amount of predilute solution (P) from the WBC bath (212), such as about 200 μL to about 250 μL of predilute solution (P) (e.g., about 200 μL or about 250 μL of predilute solution (P)), to define the extracted portion (E). In some embodiments, an upstream edge of the extracted portion (E) may be spaced apart from the diluent (D) within the diluent push/pull line (281) by the air gap (G). In this manner, air gap (G) may serve as a protective barrier between the diluent (D) and the extracted portion (E) of the predilute solution (P) to prevent the extracted portion (E) from being corrupted by the diluent (D) and thereby preserve the integrity of the extracted portion (E). For example, the extracted portion (E) may remain homogeneous and representative of the predilute solution (P) contained within the WBC bath (212). Thus, the diluent pump (249) may be configured to draw a buffer region (BU) of the extracted portion (E) into the diluent push/pull line (281) such that the second transfer line portion (276b) may be substantially filled with a transfer portion (T) of the predilute solution (P). For example, the diluent pump (249) may be configured to draw a predetermined amount of the extracted portion (E) into the second transfer line portion (276b), such as about 100 μL to about 120 μL of the extracted portion (E) (e.g., about 100 μL or about 120 μL of the extracted portion (E)), to define the transfer portion (T) of the predilute solution (P). In this regard, the diluent pump (249) may be configured to cooperate with the first and second transfer line valves (277, 278) to completely fill the second transfer line portion (276b) with the transfer portion (T) such that the transfer portion (T) may have substantially the same predetermined volume as the fixed, predetermined volume of the second transfer line portion (276b).

As shown in FIG. 5C, the diluent pump (249) is further configured to convey diluent (D) from the diluent pump (249) toward the second transfer line portion (276b) via the diluent input/output line (275), the second multi-flow unit (261), and the diluent push line (280), to convey the transfer portion (T) of the predilute solution (P) from the second transfer line portion (276b) to the RBC bath (214) via the third and fourth transfer line portions (276c, 276d), and to convey diluent (D) from the third and fourth transfer line portions (276c, 276d) to the RBC bath (214), such as when the first and second transfer line valves (277, 278) are each in a second open state (e.g., placing the diluent push line (280) and the second and third transfer line portions (276b, 276c) into fluid communication with each other) and the third transfer line valve (279) is in an open state (e.g., placing the third and fourth transfer line portions (276c, 276d) into fluid communication with each other). For example, the diluent pump (249) may be configured to deliver a predetermined amount of diluent (D) to the RBC bath (214) substantially equal to the cumulative volume of diluent (D) with which the diluent pump (249) has been charged. In some embodiments, the diluent pump (249) may be configured to deliver the diluent (D) and/or the transport portion (T) of the predilute solution (P) tangentially relative to the RBC bath (214) to promote mixing of the contents of the RBC bath (214) (e.g., the transport portion (T) of the predilute solution (P) and the delivered diluent (D)) to a homogeneous state to define a final RBC solution (FR).

As also shown in FIG. 5C, the lyse pump (242) is configured to convey lyse (L) from the lyse reservoir (232) to the WBC bath (212) via the lyse supply line (282) for mixing with the portion of the predilute solution (P) remaining therein. For example, the lyse pump (242) may be configured to deliver a predetermined amount of lyse (L) to the WBC bath (212), such as about 337.8 μL to about 575.9 μL of lyse (L) (e.g., about 337.8 μL, about 346.6 μL, about 414.2 μL, about 423 μL, about 490.6 μL, about 499.5 μL, about 567 μL, or about 575.9 μL of lyse (L)). In one example, lyse (L) is utilized to destroy red blood cells in the WBC bath (212), leaving white blood cells (WBC) for subsequent analysis (e.g., via the CBC drip chamber (221)).

As further shown in FIG. 5C, the mix pump (247) is configured to draw air (A) from atmosphere (248) and deliver mixing bubbles of air (A) to the WBC bath (212) via the mixing air line (291) and the WBC drainage line (289), such as when the mix pump valve (288) is in the first open state, to promote mixing of the contents of the WBC bath (212) (e.g., the predilute solution (P) and the lyse (L)) to a homogeneous state to define a final WBC solution (FW). The hemoglobin transducer of the WBC bath (212) is configured to measure an amount of hemoglobin present in the final WBC solution (FW). For example, the hemoglobin transducer may be configured to measure the amount of hemoglobin present in the final WBC solution (FW) upon completion of a hemoglobin incubation period, which may begin after the mixing bubbles of air (A) have been delivered to the WBC bath (212). In some embodiments, the biological analysis system (210) may be configured to initiate white blood cell count flow priming and/or data acquisition from the final WBC solution (FW) (e.g., using the CBC drip chamber (221)) upon completion of a WBC incubation period, which may also begin after the mixing bubbles of air (A) have been delivered to the WBC bath (212). In one example, a lyse (L) is used in WBC bath (212) to eliminate red blood cells (RBC), which will expose hemoglobin contained within the RBC for analysis via the hemoglobin transducer.

As shown in FIG. 5D, the mix pump (247) is also configured to draw air (A) from atmosphere (248) and deliver mixing bubbles of air (A) to the RBC bath (214) via the mixing air line (286) and the RBC drainage line (283), such as when the mix pump valve (288) is in a second open state (e.g., placing the RBC bath (214) and the mix pump (247) into fluid communication with each other), to promote mixing of the contents of the RBC bath (214) (e.g., the transport portion (T) of the predilute solution (P) and the delivered diluent (D)) to a homogeneous state to define the final RBC solution (FR). In some embodiments, the biological analysis system (210) may be configured to initiate red blood cell/platelet count flow priming and/or data acquisition from the final RBC solution (FR) (e.g., using the CBC drip chamber (221)) upon completion of mixing of the final RBC solution (FR) to homogencity.

As shown in FIG. 5E, the sweep flow tank (241) is configured to deliver diluent (D) to the sweep flow lines (271, 272) and further to the CBC chamber (221) via the common sweep flow input line (268) and the first Y-junction (269), such as when the wash-to-sweep flow valve (259) and the sweep flow valves (273, 274) are each in an open state (e.g., placing the sweep flow tank (241) and the CBC chamber (221) into fluid communication with each other). As also shown in FIG. 5E, the waste pump (245) is configured to convey residual waste fluid (W) from the CBC chamber (221) into the waste line (295) via the CBC drainage line (293) and the fourth Y-junction (296), and further to the waste receptacle (246).

As shown in FIG. 5F, the diluent pump (249) is also configured to draw diluent (D) from the sweep flow tank (241) into the diluent input line (266) and further into the diluent pump (249) such that the diluent pump (249) may be charged with diluent (D), such as when the diluent input valve (267) is in the open state. In some embodiments, the diluent pump (249) may be configured to be charged with a third predetermined volume of diluent (D) via the diluent input line (266), such as the volume of diluent (D) that is desired for subsequent flushing of the diluent input/output line (275), the diluent push line (280), and the second, third, and fourth transfer line portions (276b, 276c, 276d), as described in greater detail below.

As shown in FIG. 5G, the wash pump (240) is also configured to draw diluent (D) from the diluent reservoir (230) into the diluent supply line (250), such as when the diluent/cleaner valve (252) is in the first open state, and to convey diluent (D) to the RBC bath (214) via the first multi-flow unit (251) and the RBC input line (256), such as when the wash-to-RBC valve (257) is in an open state (e.g., placing the RBC bath (214) and the first multi-flow unit (251) into fluid communication with each other). As also shown in FIG. 5G, the diluent pump (249) is also configured to convey diluent (D) to the RBC bath (214) via the diluent input/output line (275), the second multi-flow unit (261), the diluent push line (280), and the second, third, and fourth transfer line portions (276b, 276c, 276d), such as when the first and second transfer line valves (277, 278) are each in the second open state and the third transfer line valve (279) is in the open state. In some embodiments, the diluent pump (249) may be configured to deliver the diluent (D) tangentially relative to the diluent (D) delivered by the wash pump (240). In addition, or alternatively, the diluent pump (249) may be configured to subsequently draw diluent (D) from the sweep flow tank (241) into the diluent input line (266) and further into the diluent pump (249) such that the diluent pump (249) may be charged with diluent (D), such as when the diluent input valve (267) is in the open state. In some embodiments, the diluent pump (249) may be configured to be charged with a fourth predetermined volume of diluent (D) via the diluent input line (266), such as the difference between the volume of the WBC bath (212) and the volume of the air gap (G).

As further shown in FIG. 5G, the waste pump (245) is configured to convey residual waste fluid (W) from the RBC bath (214) into the waste line (297) via the RBC drainage line (283) and the third multi-flow unit (284), and further to the waste receptacle (246), such as when the RBC drain valve (285) is in an open state (e.g., placing the third multi-flow unit (284) and the RBC bath (214) into fluid communication with each other).

As shown in FIG. 5H, the wash pump (240) is further configured to draw diluent (D) from the diluent reservoir (230) into the diluent supply line (250), such as when the diluent/cleaner valve (252) is in the first open state, and to convey diluent (D) to the second multi-flow unit (261) via the first multi-flow unit (251) and the second multi-flow unit input line (260), such as when the multi-flow input valve (262) is in an open state (e.g., placing the first and second multi-flow units (251, 261) into fluid communication with each other), and further to the WBC bath (212) via the WBC input line (264), such as when the wash-to-WBC valve (265) is in an open state (e.g., placing the WBC bath (212) and the second multi-flow unit (261) into fluid communication with each other) and the first and second transfer line valves (278) are each in a closed state, and/or via the diluent push/pull line (281) and the first and second transfer line portions (276a, 276b), such as when the first and second transfer line valves (277, 278) are each in the first open state and the wash-to-WBC valve (265) is in a closed state. In some embodiments, the wash pump (240) may be configured to deliver the diluent (D) tangentially via the first transfer line portion (276a) relative to the diluent (D) delivered via the WBC input line (264).

As further shown in FIG. 5H, the waste pump (245) is configured to convey residual waste fluid (W) from the WBC bath (212) into the waste line (297) via the WBC drainage line (289) and the third multi-flow unit (284), and further to the waste receptacle (246), such as when the WBC drain valve (290) is in an open state (e.g., placing the third multi-flow unit (284) and the WBC bath (212) into fluid communication with each other).

As shown in FIG. 5I, the diluent pump (249) is further configured to draw diluent (D) from the WBC bath (212) into the diluent input/output line (275) via the first and second transfer line portions (276a, 276b), the diluent push/pull line (281), and the second multi-flow unit (261), and further into the diluent pump (249) such that the diluent pump (249) may be charged with diluent (D), such as when the first and second transfer line valves (277a, 278) are each in the first open state. In some embodiments, the diluent pump (249) may be configured to be charged with a fifth predetermined volume of diluent (D) via the diluent input/output line (275). For example, the cumulative volume of diluent (D) with which the diluent pump (249) is configured to be charged via the diluent input line (266) and the diluent input/output line (275) may be substantially equal to the volume of diluent (D) that is desired for subsequent delivery to the WBC bath (212), such as about 2.143 mL to about 3.429 mL of diluent (D) (e.g., about 2.143 mL, about 2.571 mL, about 3 mL, or about 3.429 mL of diluent (D)), as described in greater detail below.

As also shown in FIG. 5I, the diluent pump (249) is also configured to draw air from the WBC bath (212) into the first transfer line portion (276a), such as when the first and second transfer line valves (277a, 278) are each in the first open state, to thereby form an air gap (G) within the first transfer line portion (276a) for serving as a protective barrier between the diluent (D) and the extracted portion (E) of the predilute solution (P) in a subsequent cycle.

As further shown in FIG. 5I, the CBC chamber (221) is configured to be vented (e.g., to atmosphere (248)), such as when the vacuum line valve (299) is in a first open state (e.g., placing the CBC chamber (221) and atmosphere (248) into fluid communication with each other).

As shown in FIG. 5J, the diluent pump (249) is further configured to convey diluent (D) to the WBC bath (212) via the diluent input/output line (275), the second multi-flow unit (261), and the WBC input line (264), such as when the wash-to-WBC valve (265) is in the open state, for mixing with a blood sample (B) to form the predilute solution (P) in the subsequent cycle. As also shown in FIG. 5I, the waste pump (245) is configured to convey residual waste fluid (W) from CBC chamber (221) into the waste line (297) via the CBC drainage line (293) and the third multi-flow unit (284), and further to the waste receptacle (246), such as when the CBC drain valve (294) is in an open state (e.g., placing the third multi-flow unit (284) and the CBC chamber (221) into fluid communication with each other). As further shown in FIG. 5J, the CBC chamber (221) is configured to be pressurized by the pneumatic transducer (222), such as when the vacuum line valve (299) is in a second open state (e.g., placing the pneumatic transducer (222) and the CBC chamber (221) into fluid communication with each other).

The biological analysis system (210) may be configured to complete the subsequent cycle by returning to the state shown in FIG. 5A.

It will be appreciated that, by utilizing the diluent pump (249) to aspirate the extracted portion (E) of the predilute solution (P) from the WBC bath (212) and/or by utilizing the diluent pump (249) to deliver the transfer portion (T) of the extracted portion (E) of the predilute solution (P) to the RBC bath (214), the biological analysis system (210) may have a decreased reliance on probe (216) for facilitating analysis of the blood sample (B) within the RBC bath (214), at least by comparison to systems which rely on probe (216) to aspirate a portion of the predilute solution (P) from the WBC bath (212) and/or to dispense the aspirated portion of the predilute solution (P) into the RBC bath (214). Thus, probe (216) may be configured to perform various other tasks while the diluent pump (249) aspirates the extracted portion (E) of the predilute solution (P) from the WBC bath (212) and/or while the diluent pump (249) delivers the transfer portion (T) of the extracted portion (E) of the predilute solution (P) to the RBC bath (214). For example, probe (216) may be configured to facilitate analysis of various other parameters, such as flow imaging RBC, WBC, and PLT, while the diluent pump (249) facilitates delivery of the transfer portion (T) to the RBC bath (214).

It will also be appreciated that, by excluding the RBC bath (214) from the path of the probe (216), the biological analysis system (210) may reduce the complexity and/or footprint of the path of the probe (216), at least by comparison to systems which include the RBC bath (214) along the path of the probe (216), and may thereby enable the biological analysis system (210) to have a reduced overall size, at least by comparison to such systems.

Though the embodiments herein have described a WBC bath (212) and RBC bath (214) linked to a CBC drip chamber (221), other embodiments are contemplated utilizing the pump fluid transfer techniques contemplated herein. For instance, a WBC bath (212) and RBC bath (214) can be used in a blood analysis system utilizing flow imaging where, for instance, a WBC bath (212) and RBC bath (214) are linked to a flowcell such that the contents of each are conveyed through a flowcell for imaging by a high speed, high resolution camera. The principle of using a pump (249) to facilitate fluid transfer between chambers or baths of an analysis system to reduce reliance on a probe (216) can broadly be used to reduce systems load and increase throughput in a variety of settings.

Note, other embodiments (e.g., systems and associated methods) utilize a wash pump/syringe pump fluid transfer system as contemplated herein. For instance, a probe (216) can initially deliver a diluent and a blood sample to an RBC bath (214), where the sample mixture/predilute solution is then conveyed to a WBC bath (212) via pump (249). Other embodiments can utilize more than two baths (212, 214), where pump (249) is used to convey a blood sample solution (e.g., a mixture of blood and diluent) between one or more of the more than two baths. For instance, rather than incorporating an HGB transducer with WBC bath (212) for the purposes of hemoglobin measurements, a third bath can be utilized for this purpose.

### D. SECOND EXEMPLARY METHOD EMBODIMENTS OF ANALYZING A BIOLOGICAL SAMPLE

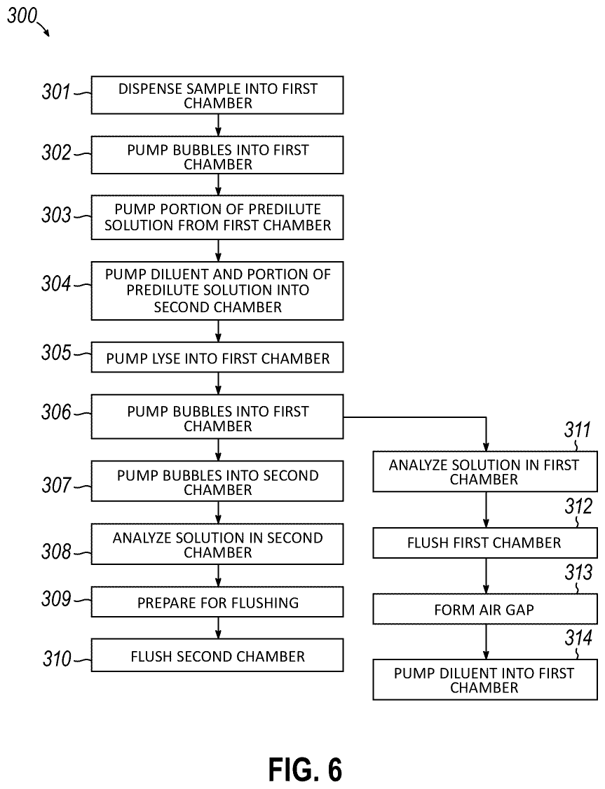

FIG. 6 shows another exemplary method (300) of analyzing a biological sample, such as the blood sample (B). While the method (300) is described as being performed using the biological analysis system (210) described above, it will be appreciated that the method (300) may be performed using any suitable biological analysis system.

The method (300) begins with step (301), at which blood sample (B) is dispensed into a first fluid analysis chamber, such as the WBC bath (212). In some embodiments, step (301) may be performed by delivering a predetermined amount of blood sample (B) to the WBC bath (212), such as about 10 μL to about 16 μL of blood sample (B), via the probe (216) for mixing with the diluent (D) contained therein as described above in connection with FIG. 5A. It will be appreciated that, prior to step (301), the method (300) may include aspirating blood sample (B) from a specimen (not shown) via the probe (216) at a home position and then navigating the probe (216) along a path from the home position to the WBC bath (212) for dispensing blood sample (B) into the WBC bath (212). The method (300) may also include returning the probe (216) to the home position from the WBC bath (212) without reaching the RBC bath (214).

In addition, or alternatively, prior to step (301), the method (300) may include forming an air gap (G) within the first transfer line portion (276a), such as by drawing air from the WBC bath (212) into the first transfer line portion (276a), via the diluent pump (249) as described above in connection with FIG. 5I. In addition, or alternatively, prior to step (301), the method (300) may include pumping or otherwise conveying diluent (D) into the WBC bath (212), such as by delivering a predetermined amount of diluent (D) to the WBC bath (212), such as about 2.143 mL to about 3.429 mL of diluent (D), via the diluent pump (249) as described above in connection with FIG. 5J.

The method (300) proceeds from step (301) to step (302), at which mixing bubbles of air (A) are pumped or otherwise conveyed into the first fluid analysis chamber, such as the WBC bath (212). In some embodiments, step (302) may be performed by delivering bursts of mixing bubbles of air (A) to the WBC bath (212), via the mix pump (247) to promote mixing of the contents of the WBC bath (212) to a homogeneous state to define the predilute solution (P) as described above in connection with FIG. 5A.

The method (300) proceeds from step (302) to step (303), at which the extracted portion (E) of the predilute solution (P) is pumped or otherwise aspirated from the first fluid analysis chamber, such as the WBC bath (212). In some embodiments, step (303) may be performed by drawing a predetermined amount of predilute solution (P) from the WBC bath (212), such as about 200 μL to about 250 μL of predilute solution (P), to define the extracted portion (E) via the diluent pump (249), and by drawing the air gap (G) and the buffer region (BU) of the extracted portion (E) into the diluent push/pull line (281) such that a predetermined amount of the extracted portion (E), such as about 100 μL to about 120 μL of the extracted portion (E), substantially fills the second transfer line portion (276b) to define a transfer portion (T) of the predilute solution (P) as described above in connection with FIG. 5B. Thus, step (303) may be performed without utilizing probe (216) to aspirate the transfer portion (T) of predilute solution (P) from the WBC bath (216), thereby freeing up probe (216) to perform other tasks contemporancously with performance of step (303).

The method (300) proceeds from step (303) to step (304), at which diluent (D) and the transfer portion (T) of predilute solution (P) are pumped or otherwise conveyed into the second fluid analysis chamber, such as the RBC bath (214). In some embodiments, step (304) may be performed by delivering the transfer portion (T) of the predilute solution (P) and a predetermined amount of diluent (D) to the RBC bath (214), such as about 2.804 mL to about 3.364 mL of diluent (D), via the diluent pump (249) as described above in connection with FIG. 5C. Thus, step (304) may be performed without utilizing probe (216) to deliver the transfer portion (T) of predilute solution (P) to the RBC bath (214), thereby freeing up probe (216) to perform other tasks contemporaneously with performance of step (304).

The method (300) proceeds from step (304) to step (305), at which lyse (L) is pumped or otherwise conveyed into the first fluid analysis chamber, such as the WBC bath (212). In some embodiments, step (305) may be performed by delivering a predetermined amount of lyse (L) to the WBC bath (212), such as about 337.8 μL to about 575.9 μL of lyse (L), for mixing with the portion of the predilute solution (P) remaining therein via the lyse pump (242) as described above in connection with FIG. 5C. It will be appreciated that step (305) may alternatively be performed prior to or contemporaneously with step (304).

The method (300) proceeds from step (305) to step (306), at which mixing bubbles of air (A) are pumped or otherwise conveyed into the first fluid analysis chamber, such as the WBC bath (212). In some embodiments, step (306) may be performed by delivering bursts of mixing bubbles of air (A) to the WBC bath (212), via the mix pump (247) to promote mixing of the contents of the WBC bath (212) to a homogeneous state to define the final WBC solution (FW) as described above in connection with FIG. 5C.

The method (300) proceeds from step (306) to step (307), at which mixing bubbles of air (A) are pumped or otherwise conveyed into the second fluid analysis chamber, such as the RBC bath (214). In some embodiments, step (307) may be performed by delivering bursts of mixing bubbles of air (A) to the RBC bath (214), via the mix pump (247) to promote mixing of the contents of the RBC bath (214) to a homogeneous state to define the final RBC solution (FR) as described above in connection with FIG. 5D.

The method (300) proceeds from step (307) to step (308), at which the final RBC solution (FR) in the second fluid analysis chamber, such as the RBC bath (214), is analyzed. In some embodiments, step (308) may be performed immediately after completion of step (307). In any event, step (308) may include initiating red blood cell/platelet count flow priming and/or data acquisition from the final RBC solution (FR). In addition, or alternatively, step (308) may include pumping or otherwise conveying diluent (D) from the sweep flow tank (241) to the CBC chamber (221) as described above in connection with FIG. 5E. It will be appreciated that step (307) may be performed in parallel with one or more of steps (305, 306).

The method (300) proceeds from step (308) to step (309), at which the diluent pump (249) is prepared for flushing the diluent input/output line (275), the diluent push line (280), and the second, third, and fourth transfer line portions (276b, 276c, 276d). In some embodiments, step (309) may be performed by charging the diluent pump (249) with a predetermined volume of diluent (D) for flushing the diluent input/output line (275), the diluent push line (280), and the second, third, and fourth transfer line portions (276b, 276c, 276d) as described above in connection with FIG. 5F.

The method (300) proceeds from step (309) to step (310), at which the RBC bath (214) is flushed and thereby cleaned and/or emptied of any waste fluids (W) contained therein. In some embodiments, step (310) may be performed by conveying diluent (D) to the RBC bath (214) via wash pump (240) and diluent pump (249), and/or by expelling the waste fluids (W) and/or diluent (D) from the RBC bath (214) via the waste pump (245) as described above in connection with FIG. 5G. It will be appreciated that at the conclusion of step (310), the RBC bath (214) will be substantially empty.

In the example shown, the method (300) also proceeds from step (306) to step (311), at which the final WBC solution (FW) in the first fluid analysis chamber, such as the WBC bath (212), is analyzed. In some embodiments, step (311) may be performed upon completion of one or more incubation periods which may begin after the mixing bubbles of air (A) have been delivered to the WBC bath (212) during performance of step (306). For example, step (311) may include measuring an amount of hemoglobin present in the final WBC solution (FW), such as via the hemoglobin transducer of the WBC bath (212), upon completion of the hemoglobin incubation period. In addition, or alternatively, step (311) may include initiating white blood cell count flow priming and/or data acquisition from the final WBC solution (FW) upon completion of the WBC incubation period. It will be appreciated that step (311) may be performed in parallel with one or more of steps (307, 308, 309, 310).

The method (300) proceeds from step (311) to step (312), at which the WBC bath (212) is flushed and thereby cleaned and/or emptied of any waste fluids (W) contained therein. In some embodiments, step (312) may be performed by conveying diluent (D) to the WBC bath (212) via diluent pump (249), and/or by expelling the waste fluids (W) and/or diluent (D) from the WBC bath (212) via the waste pump (245) as described above in connection with FIG. 5H. It will be appreciated that at the conclusion of step (312), the WBC bath (212) will be substantially empty.

The method (300) proceeds from step (312) to step (313), at which the air gap (G) for the next cycle is formed. In some embodiments, step (313) may be performed by drawing air from the WBC bath (212) into the first transfer line portion (276a), via the diluent pump (249) as described above in connection with FIG. 5I.

The method (300) proceeds from step (313) to step (314), at which diluent (D) for the next cycle is pumped or otherwise conveyed into the first fluid analysis chamber, such as the WBC bath (212). In some embodiments, step (314) may be performed by delivering a predetermined amount of diluent (D) to the WBC bath (212), such as about 2.143 mL to about 3.429 mL of diluent (D), via the diluent pump (249) as described above in connection with FIG. 5J.

In some embodiments, after steps (313, 314) are completed, the method (300) may return to step (301) in which another blood sample (B) is dispensed into the first fluid analysis chamber, such as the WBC bath (212), to perform the next cycle.

### E. EXAMPLES OF COMBINATIONS

The following examples relate to various non-exhaustive ways in which the teachings herein may be combined or applied. It should be understood that the following examples are not intended to restrict the coverage of any claims that may be presented at any time in this application or in subsequent filings of this application. No disclaimer is intended. The following examples are being provided for nothing more than merely illustrative purposes. It is contemplated that the various teachings herein may be arranged and applied in numerous other ways. It is also contemplated that some variations may omit certain features referred to in the below examples. Therefore, none of the aspects or features referred to below should be deemed critical unless otherwise explicitly indicated as such at a later date by the inventors or by a successor in interest to the inventors. If any claims are presented in this application or in subsequent filings related to this application that include additional features beyond those referred to below, those additional features shall not be presumed to have been added for any reason relating to patentability.

### Example 1

A biological analysis system comprising: (a) a probe, wherein the probe is configured to dispense a biological sample into a first chamber; and (b) a pump, wherein the pump is configured to: (i) convey a first delivery of diluent to the first chamber for mixing with the biological sample to produce a sample mixture, (ii) aspirate a portion of the sample mixture from the first chamber, and (iii) convey the portion of the sample mixture to a second chamber.

### Example 2

The biological analysis system of Example 1, wherein the probe is configured to aspirate the biological sample from a biological specimen prior to dispensing the biological sample into the first chamber.

### Example 3

The biological analysis system of any of Examples 1 through 2, wherein the pump comprises a syringe pump.

### Example 4

The biological analysis system of any of Examples 1 through 3, further comprising a CBC drip chamber, wherein the CBC drip chamber is configured to count blood cells within at least one of the first or second chambers.

### Example 5

The biological analysis system of any of Examples 1 through 4, wherein the pump is configured to convey a second delivery of diluent to the second chamber while conveying the portion of the sample mixture to the second chamber.

### Example 6

The biological analysis system of any of Examples 1 through 5, further comprising a lyse pump, wherein the lyse pump is configured to convey a lyse to the first chamber.

### Example 7

The biological analysis system of any of Examples 1 through 6, further comprising the first and second chambers, wherein the first and second chambers are configured to be selectively fluidly coupled to each other.

### Example 8

The biological analysis system of Example 7, further comprising a transfer line configured to selectively fluidly couple the first and second chambers to each other, wherein the pump is configured to aspirate the portion of the sample mixture into the transfer line prior to conveying the portion of the sample mixture to the second chamber through the transfer line.

### Example 9

The biological analysis system of Example 8, further comprising at least one diluent push/pull line configured to be selectively fluidly coupled to the transfer line, wherein the pump is configured to draw an air gap into the at least one diluent push/pull line while aspirating the portion of the sample mixture into the transfer line.

### Example 10

A biological analysis system comprising: (a) a first chamber; (b) a second chamber; (c) a probe, wherein the probe is configured to dispense a biological sample into the first chamber; (d) a first pump, wherein the first pump is configured to transfer a portion of the biological sample from the first chamber to the second chamber; and (e) a second pump, wherein the second pump is configured to convey a fluid medium to at least one of the first chamber or the second chamber.

### Example 11

The biological analysis system of Example 10, wherein the fluid medium includes a lyse, wherein the second pump is configured to convey the lyse to the first chamber after transfer of the portion of the biological sample to the second chamber.

### Example 12

The biological analysis system of any of Examples 10 through 11, further comprising a CBC drip chamber, wherein the CBC drip chamber is fluidly coupled to at least one of the first or second chambers for counting blood cells within the at least one of the first or second chambers.

### Example 13

The biological analysis system of any of Examples 10 through 12, wherein the first pump is configured to convey a first delivery of diluent to the first chamber for mixing with the biological sample to produce a sample mixture prior to transfer of the portion of the biological sample to the second chamber.

### Example 14

The biological analysis system of Example 13, wherein the first pump is configured to convey a second delivery of diluent to the second chamber during transfer of the portion of the biological sample to the second chamber.

### Example 15

The biological analysis system of any of Examples 10 through 14, wherein the first and second chambers are configured to be selectively fluidly coupled to each other.

### Example 16

The biological analysis system of Example 15, further comprising: (a) a transfer line configured to selectively fluidly couple the first and second chambers to each other; and (b) at least one diluent push/pull line configured to be selectively fluidly coupled to the transfer line, wherein the first pump is configured to draw an air gap into the at least one diluent push/pull line while aspirating the portion of the biological sample into the transfer line.

### Example 17

The biological analysis system of any of Examples 10 through 16, wherein the first chamber comprises a hemoglobin transducer.

### Example 18

The biological analysis system of Example 17, wherein the hemoglobin transducer comprises a filtered light source and an optical sensor.

### Example 19

A method of analyzing a biological sample, comprising: (a) conveying a diluent to a first chamber via a first pump; (b) dispensing a blood sample into the first chamber via a probe to produce a sample mixture; and (c) conveying a portion of the sample mixture from the first chamber to a second chamber via the first pump.

### Example 20

The method of Example 19, further comprising conveying a lyse to the first chamber via a second pump.

### Example 21

The biological analysis system of Example 8, further comprising a pair of transfer line valves positioned along the transfer line, wherein the pair of transfer line valves are spaced apart from each other by a transfer line portion, wherein the transfer line portion has a fixed volume such that the transfer line portion is configured to receive the portion of the sample mixture having a predetermined volume substantially equal to the fixed volume of the transfer line portion.

### Example 22

The biological analysis system of Example 21, wherein each transfer line valve of the pair of transfer line valves includes a three-way valve.

### Example 23

The biological analysis system of Example 9, wherein the at least one diluent push/pull line includes a pair of diluent push/pull lines.

### Example 24

The biological analysis system of Example 23, further comprising a pair of three-way valves positioned along the transfer line, each three-way valve of the pair of three-way valves being coupled to a respective diluent push/pull line of the pair of diluent push/pull lines.

### Example 25

The biological analysis system of Example 24, wherein the pair of three-way valves are spaced apart from each other by a transfer line portion, wherein the transfer line portion has a fixed volume.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. In certain cases, method steps or operations may be performed or executed in differing order, or operations may be added, deleted or modified. It can be appreciated that, in certain aspects of the invention, a single component may be replaced by multiple components, and multiple components may be replaced by a single component, to provide an element or structure or to perform a given function or functions. Except where such substitution would not be operative to practice certain embodiments of the invention, such substitution is considered within the scope of the invention. Accordingly, the present invention is not limited to the embodiments described above or depicted in the drawings, and various embodiments and modifications can be made without departing from the scope of the claims below.

1. A biological analysis system comprising:
a probe configured to dispense a biological sample into a first chamber;
a pump configured to:
convey a first delivery of diluent to the first chamber for mixing with the biological sample to produce a sample mixture,
aspirate a portion of the sample mixture from the first chamber, and
convey the portion of the sample mixture to a second chamber.

2. The biological analysis system of claim 1, wherein the probe is configured to aspirate the biological sample from a biological specimen prior to dispensing the biological sample into the first chamber.

3. The biological analysis system of claim 1, further comprising a CBC drip chamber, wherein the CBC drip chamber is configured to count blood cells within at least one of the first or second chambers.

4. The biological analysis system of claim 1, wherein the pump is configured to convey a second delivery of diluent to the second chamber while conveying the portion of the sample mixture to the second chamber.

5. The biological analysis system of claim 1, further comprising a lyse pump, wherein the lyse pump is configured to convey a lyse to the first chamber.

6. The biological analysis system of claim 1, wherein the first and second chambers are configured to be selectively fluidly coupled to each other.

7. The biological analysis system of claim 6, further comprising a transfer line configured to selectively fluidly couple the first and second chambers to each other, wherein the pump is configured to aspirate the portion of the sample mixture into the transfer line prior to conveying the portion of the sample mixture to the second chamber through the transfer line.

8. The biological analysis system of claim 1, further comprising a pair of transfer line valves positioned along the transfer line, wherein the pair of transfer line valves are spaced apart from each other by a transfer line portion, wherein the transfer line portion has a fixed volume such that the transfer line portion is configured to receive the portion of the sample mixture having a predetermined volume substantially equal to the fixed volume of the transfer line portion.

9. The biological analysis system of claim 8, wherein each transfer line valve of the pair of transfer line valves includes a three-way valve.

10. The biological analysis system of claim 8, further comprising at least one diluent push/pull line configured to be selectively fluidly coupled to the transfer line, wherein the pump is configured to draw an air gap into the at least one diluent push/pull line while aspirating the portion of the sample mixture into the transfer line.

11. The biological analysis system of claim 10, wherein the at least one diluent push/pull line includes a pair of diluent push/pull lines.

12. The biological analysis system of claim 11, further comprising a pair of three-way valves positioned along the transfer line, each three-way valve of the pair of three-way valves being coupled to a respective diluent push/pull line of the pair of diluent push/pull lines.

13. The biological analysis system of claim 12, wherein the pair of three-way valves are spaced apart from each other by a transfer line portion, wherein the transfer line portion has a fixed volume.

14. A biological analysis system comprising:
a first chamber;
a second chamber;
a probe, wherein the probe is configured to dispense a biological sample into the first chamber;
a first pump, wherein the first pump is configured to transfer a portion of the biological sample from the first chamber to the second chamber; and
a second pump, wherein the second pump is configured to convey a fluid medium to at least one of the first chamber or the second chamber.

15. The biological analysis system of claim 14, wherein the fluid medium includes a lyse, wherein the second pump is configured to convey the lyse to the first chamber after transfer of the portion of the biological sample to the second chamber.

16. The biological analysis system of claim 14, further comprising a CBC drip chamber, wherein the CBC drip chamber is fluidly coupled to at least one of the first or second chambers for counting blood cells within the at least one of the first or second chambers.

17. The biological analysis system of claim 14, wherein the first pump is configured to convey a first delivery of diluent to the first chamber for mixing with the biological sample to produce a sample mixture prior to transfer of the portion of the biological sample to the second chamber.

18. The biological analysis system of claim 17, wherein the first pump is configured to convey a second delivery of diluent to the second chamber during transfer of the portion of the biological sample to the second chamber.

19. The biological analysis system of claim 13, wherein the first chamber comprises a hemoglobin transducer, wherein the hemoglobin transducer comprises a filtered light source and an optical sensor.

20. A method of analyzing a biological sample, comprising:
conveying a diluent to a first chamber via a first pump;
dispensing a blood sample into the first chamber via a probe to produce a sample mixture; and
conveying a portion of the sample mixture from the first chamber to a second chamber via the first pump.
